(19) United States
(12) Patent Application Publication
(10) Pub. No.: US 2006/0199156 A1
(43) Pub. Date: Sep. 7, 2006

(54) Typing game apparatus

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/364,415

(22) Filed: Mar. 1, 2006

(30) Foreign Application Priority Data
Mar. 2, 2005 (JP) 2005-056740
Mar. 2, 2005 (JP) 2005-056741

(51) Int. Cl. G09B 13/00; A63F 13/00

(52) U.S. Cl. 434/227; 463/1

(57) ABSTRACT

If the portion of the lyrics of a song which is being reproduced is not the first verse and when the evaluation related to typing is in an unfavorable state, screen division is performed, and the display state of the image of a PV which is being displayed on a second liquid crystal display is made one step worse. On the other hand, if the portion of the lyrics of a song which is being reproduced is the first verse, then the image of the PV of this song is clearly displayed in a full screen on the second liquid crystal display.

### RELATED APPLICATIONS

This application claims the priority of Japanese Patent Application Nos. 2005-056740 and 2005-056741 filed on Mar. 2, 2005, which are incorporated herein by reference.

### BACKGROUND OF THE INVENTION

1. Field of the Invention

The present invention relates to a typing game apparatus on which lyrics of a song, which are to be the object of typing, are displayed simultaneously with a promotion video for the song.

2. Description of the Prior Art

In the past, with a typing game apparatus, although it has been possible to perform typing practice to which playability has been added, as described for example in Japanese Unexamined Patent Publication No. 2002-268534, the format of this typing practice has been, while music is being reproduced along with an image, to perform key input of the corresponding lyrics, and to compete with regard to the correctness and the timing and so on of this key input.

In this respect, according to the description in the above described Japanese Unexamined Patent Publication No. 2002-268534, it is also possible to reproduce only the music without performing image reproduction or display of the lyrics; and, if this is done, it is also possible to perform key input of the lyrics corresponding to the music which is being reproduced, and to compete with regard to the correctness and the timing and so on of this key input, while only relying on auditory information.

However, in a case such as when the music which is being reproduced is a public performance of a song which is disseminated via a medium such as CD, DVD, or television, and the image which is being reproduced along with this music is a promotion video for it, if it is so arranged that reproduction of this image which is the promotion video is not performed (which is undesirable), then the opportunity for manifesting the functions which are possessed by this promotion video, such as attractiveness to the public and the beneficial publicity effect directed towards promotion of the sales of the CD, DVD and so on, is utterly wasted; while, conversely, if it is so arranged that the reproduction of this image which is the promotion video is always performed from its very beginning to its very end, then, while the opportunity of manifesting the functions which the promotion video possesses is indeed sufficiently ensured, the speed with which the freshness of this promotion video is lost becomes quick, and accordingly the function which the promotion video possesses quickly deteriorates.

### SUMMARY OF THE INVENTION

The present invention has been conceived in the light of the above described problems, and its object is to provide a typing game apparatus with which, while the skill related to typing is made to appeal to onlookers by taking advantage of a promotion video which possesses attractiveness for the public, also, by changing the way this promotion video is displayed, it is possible sufficiently to manifest a beneficial effect for publicity directed towards the promotion of the sales of a CD or a DVD or the like which contains the promotion video.

In order to attain the above described object, and others, the invention according to claim 1 proposes a typing game apparatus (for example, the typing game apparatus 1), including: storage means (for example, the HDD 55), on which are stored image data and music data including, at least, musical instrument data, voice data, lyrics data, and determination standard data; musical performance processing means (for example, the CPU 51 and the sound control circuit 61) which performs a song by outputting a musical instrument and a voice, based on the music data stored in the storage means (for example, the HDD 55); first image display means (for example, the first liquid crystal display 3) on which predetermined character strings which are parts of lyrics of the song are displayed in order while being matched with a progression of the song which is being performed by the musical performance processing means (for example, the CPU 51 and the sound control circuit 61); second image display means (for example, the second liquid crystal display 4) on which the image data stored in the storage means (for example, the HDD 55) is displayed; image display control means (for example, the CPU 51 and the display control circuit 60) which controls an operation of the first image display means (for example, the first liquid crystal display 3) and the second image display means (for example, the second liquid crystal display 4), based on the music data stored in the storage means (for example, the HDD 55); input means (for example, the keyboard 6) on which are arranged a plurality of keys which correspond to a plurality of characters; correctness determination means (for example, the CPU 51 and the step S28) which determines, with a determination standard based on the music data stored in the storage means (for example, the HDD 55), whether or not a character string, which is input by typing by pressing down keys of the input means (for example, the keyboard 6), agrees with the predetermined character string; play development control means (for example, the CPU 51) which controls a development of play, based on a determination result of the correctness determination means (for example, the CPU 51 and the step S28); first condition determination means (for example, the CPU 51 and the step S101) which determines whether or not a first condition in which a predetermined state holds for the song which is being performed by the musical performance processing means (for example, the CPU 51 and the sound control circuit 61) is satisfied; normal screen display control means (for example, the CPU 51, the display control circuit 60, and the step S102) which, if it is determined by the first condition determination means (for example, the CPU 51 and the step S101) that the first condition is satisfied, causes the second image display means (for example, the second liquid crystal display 4) to perform an operation to display the image data stored in the storage means (for example, the HDD 55) in a normal screen state; second condition determination means (for example, the CPU 51 and the step S103) which determines whether or not a second condition in which a result of determination by the correctness determination means (for example, the CPU 51 and the step S28) is at or above a predetermined standard, is satisfied; and abnormal screen display control means (for example, the CPU 51, the display control circuit 60, and the step S105) which, if it is determined by the first condition determination means (for example, the CPU 51 and the step S101) that the first condition is not satisfied, and when evaluation related to the typing on the input means (for example, the keyboard 6) is in an unfavorable state due to a determination by the second condition determination means (for example, the CPU 51 and the step S103) that the second condition is not satisfied, causes the second image display means (for example, the second liquid crystal display 4) to perform an operation to display a screen in which the image data stored in the storage means (for example, the HDD 55) is displayed in an abnormal screen state which is different from the normal screen state.

Furthermore, in order to attain the above described object, and others, the invention according to claim 2 proposes a typing game apparatus (for example, the typing game apparatus 1) as described in the invention according to claim 1, wherein the normal screen display control means comprises full screen display control means (for example, the CPU 51, the display control circuit 60, and the step S102) which causes the second image display means (for example, the second liquid crystal display 4) to perform an operation to display the image data stored in the storage means (for example, the HDD 55) in a full screen state; and wherein the abnormal screen display control means comprises screen division display control means (for example, the CPU 51, the display control circuit 60, and the step S105) which causes the second image display means (for example, the second liquid crystal display 4) to perform an operation to divide into a plurality of sections a screen in which the image data stored in the storage means (for example, the HDD 55) is displayed.

Furthermore, the invention according to claim 3 proposes a typing game apparatus (for example, the typing game apparatus 1) as described in the invention according to claim 2, further including division cancellation display control means (for example, the CPU 51, the display control circuit 60, and the step S104) which, if it is determined by the first condition determination means (for example, the CPU 51 and the step S101) that the first condition is not satisfied, and when the evaluation relating to the typing on the input means (for example, the keyboard 6) is in a favorable state due to a determination by the second condition determination means (for example, the CPU 51 and the step S103) that the second condition is satisfied causes the second image display means (for example, the second liquid crystal display 4) to perform an operation to cancel screen division of the display of the image data stored in the storage means (for example, the HDD 55).

Furthermore, the invention according to claim 4 proposes a typing game apparatus as described in the invention according to claim 2, wherein the input means comprises a keyboard (for example, keyboard 6), and, in an interior of each key on the keyboard, there is provided an LED section which emits light of a first color if input operation via the key is correct, and emits light of a second color if the input operation via the key is incorrect.

Furthermore, the invention according to claim 5 proposes a typing game apparatus as described in the invention according to claim 2, wherein the screen division display control means (for example, the CPU 51, the display control circuit 60, and the step S105) is changeable from a full screen display in which the screen is not divided to a 4-division screen display, and furthermore is changeable from the 4-division screen display to a 16-division screen display.

Furthermore, the invention according to claim 6 proposes a typing game apparatus as described in the invention according to claim 2, wherein the operation of dividing the screen (for example, step S105) by the screen division display control means (for example, the CPU 51, the display control circuit 60, and the step S105) is performed when a typing error has occurred during a character input.

Furthermore, the invention according to claim 7 proposes a typing game apparatus as described in the invention according to claim 3, wherein the operation of canceling the screen division (for example, step S104) by the division cancellation display control means (for example, the CPU 51, the display control circuit 60, and the step S104) is performed when an input of a predetermined number of characters has been performed without any typing errors.

And, in order to attain the above described object, and others, the invention according to claim 8 proposes a typing game apparatus (for example, the typing game apparatus 1) as described in the invention according to claim 1, wherein the normal screen display control means comprises full screen display control means (for example, the CPU 51, the display control circuit 60, and the step S102) which causes the second image display means (for example, the second liquid crystal display 4) to perform an operation to display the image data stored in the storage means (for example, the HDD 55) in a full screen state; and wherein the abnormal screen display control means comprises screen disordering display control means (for example, the CPU 51, the display control circuit 60, and the step S105) which causes the second image display means (for example, the second liquid crystal display 4) to perform an operation to disorder a screen in which the image data stored in the storage means (for example, the HDD 55) is displayed.

Furthermore, the invention according to claim 9 proposes a typing game apparatus (for example, the typing game apparatus 1) as described in the invention according to claim 8, further including disordering elimination display control means (for example, the CPU 51, the display control circuit 60, and the step S104) which, if it is determined by the first condition determination means (for example, the CPU 51 and the step S101) that the first condition is not satisfied, and when the evaluation relating to typing on the input means (for example, the keyboard 6) is in a favorable state due to a determination by the second condition determination means (for example, the CPU 51 and the step S103) that the second condition is satisfied causes the second image display means (for example, the second liquid crystal display 4) to perform an operation to eliminate screen disordering of the display of the image data stored in the storage means (for example, the HDD 55).

Furthermore, the invention according to claim 10 proposes a typing game apparatus (for example, the typing game apparatus 1) as described in the invention according to claim 8, wherein the disordering of the image data on the display screen of the second image display means (for example, the second liquid crystal display 4) comprises generation of noise therein.

Furthermore, the invention according to claim 11 proposes a typing game apparatus (for example, the typing game apparatus 1) as described in the invention according to claim 8, wherein the disordering of the image data on the display screen of the second image display means (for example, the second liquid crystal display 4) comprises generation of displacement thereof on the display screen.

Furthermore, the invention according to claim 12 proposes a typing game apparatus (for example, the typing game apparatus 1) as described in the invention according to claim 11, wherein the displacement on the display screen of the image data of the second image display means (for example, the second liquid crystal display 4) comprises shifting of the display screen in a vertical direction.

Furthermore, the invention according to claim 13 proposes a typing game apparatus as described in the invention according to claim 8, wherein the input means comprises a keyboard (for example, the keyboard 6), and, in an interior of each key on the keyboard, there is provided a LED section which emits light of a first color if input operation via the key is correct, and emits light of a second color if the input operation via the key is incorrect.

Furthermore, the invention according to claim 14 proposes a typing game apparatus as described in the invention according to claim 8, wherein the screen disordering display control means (for example, the CPU 51, the display control circuit 60, and the step S205) is changeable from a screen display in which no noise is generated to a first stage noisy screen display in which noise is generated to a first extent, and furthermore is changeable from the first stage noisy screen display to a second stage noisy screen display in which more noise is generated than in the first stage noisy screen display.

Furthermore, the invention according to claim 15 proposes a typing game apparatus as described in the invention according to claim 14, wherein a change operation of the noisy screen display (for example, step S205) by the screen disordering display control means (for example, the CPU 51, the display control circuit 60, and the step S205) is performed when a typing error in a character input has occurred.

Furthermore, the invention according to claim 16 proposes a typing game apparatus as described in the invention according to claim 14, wherein the operation of eliminating noise generation on the screen (for example, step S204) by the disordering elimination display control means (for example, the CPU 51, the display control circuit 60, and the step S204) is performed when an input of a predetermined number of characters has been performed without any typing errors.

Furthermore, the invention according to claim 17 proposes a typing game apparatus as described in the invention according to claim 12, wherein the screen disordering display control means (for example, the CPU 51, the display control circuit 60, and the step S205) is changeable from a screen display in which no shifting of the display screen in the vertical direction is generated to a first stage shifted screen display in which shifting of the display screen in the vertical direction to a first extent is generated, and furthermore is changeable from the first stage shifted screen display to a second stage shifted screen display in which more shifting of the display screen in the vertical direction is generated than in the first stage shifted screen display.

Furthermore the invention according to claim 18 proposes a typing game apparatus as described in the invention according to claim 17, wherein a change operation of the shifted screen display by the screen disordering display control means (for example, the CPU 51, the display control circuit 60, and the step S205) is performed when a typing error has occurred in a character input.

Furthermore, the invention according to claim 19 proposes a typing game apparatus as described in the invention according to claim 17, wherein the operation of eliminating shifting of the screen (for example, step S204) in the vertical direction by the disordering elimination display control means (for example, the CPU 51, the display control circuit 60, and the step S204) is performed when input of a predetermined number of characters has been performed without any typing errors.

It should be understood that the term “image data” refers both to a moving image (including a slow motion image, a fast motion image, and a reverse motion image) and to a still image.

Furthermore, although normally “image data” refers to a promotion video for the song which is being displayed on the second image display means (for example, on the second liquid crystal display 4) during the progress of the song which is being performed by the musical performance processing means (for example, the CPU 51 and the sound control circuit 61), alternatively, it might also be another image which has no relationship with the song (such as, for example, a CM image, an animation image, a promotion video for an artist different from the artist who is performing the song, or the like).

### BRIEF DESCRIPTION OF THE DRAWINGS

FIG. 1 is a perspective view of a typing game apparatus according to a first embodiment;

FIG. 2 is a schematic view showing contents displayed on a first liquid crystal display before the start of a typing game;

FIG. 3A is a schematic view showing contents displayed on a second liquid crystal display during the progression of the typing game, and FIG. 3B is a schematic view showing contents displayed on the first liquid crystal display during the progression of the typing game;

FIG. 4A is a schematic view showing contents displayed on the second liquid crystal display during the progression of the typing game, and FIG. 4B is a schematic view showing contents displayed on the first liquid crystal display during the progression of the typing game;

FIG. 5 is a schematic view showing contents displayed on the first liquid crystal display after the end of the typing game;

FIG. 6 is a plan view showing a keyboard incorporated in this typing game apparatus according to the first embodiment;

FIG. 7 is a schematic sectional view showing a section of one of a plurality of keys provided to this keyboard;

FIG. 8 is a system block diagram showing a system which consists of this typing game apparatus according to the first embodiment, and a server;

FIG. 9 is a block diagram, schematically showing a control system for this typing game apparatus according to the first embodiment;

FIG. 10 is a schematic view showing a music data storage region of an HDD of this typing game apparatus according to the first embodiment;

FIG. 11 is a flow chart of a main processing program of this typing game apparatus according to the first embodiment;

FIG. 12 is a flow chart of a song selection processing program of this typing game apparatus according to the first embodiment;

FIG. 13 is a flow chart of a typing game execution processing program of this typing game apparatus according to the first embodiment;

FIG. 14 is a flow chart of a second liquid crystal display processing program of this typing game apparatus according to the first embodiment, which is performed at a time point W1 of FIG. 13;

FIG. 15 is a figure showing the shifting progress of the display state of the second liquid crystal display of this typing game apparatus according to the first embodiment;

FIG. 16 is a figure showing a normal screen state of the second liquid crystal display of this typing game apparatus according to the first embodiment;

FIG. 17 is a figure showing an example of a 4-division screen state of the second liquid crystal display of this typing game apparatus according to the first embodiment;

FIG. 18 is a figure showing an example of a 16-division screen state of the second liquid crystal display of this typing game apparatus according to the first embodiment;

FIG. 19 is a figure showing a second example of a 16-division screen state of the second liquid crystal display of this typing game apparatus according to the first embodiment;

FIG. 20 is a figure showing a third example of a 16-division screen state of the second liquid crystal display of this typing game apparatus according to the first embodiment;

FIG. 21 is a figure showing a fourth example of a 16-division screen state of the second liquid crystal display of this typing game apparatus according to the first embodiment;

FIG. 22 is a flow chart of the second liquid crystal display processing program of this typing game apparatus according to the first embodiment which is performed at a time point W2 of FIG. 13;

FIG. 23 is a figure showing the shifting progress of the display state of a second liquid crystal display of a typing game apparatus according to a second embodiment;

FIG. 24 is a figure showing an example of a first noisy screen state of the second liquid crystal display of this typing game apparatus according to the second embodiment;

FIG. 25 is a figure showing an example of a second noisy screen state of the second liquid crystal display of this typing game apparatus according to the second embodiment;

FIG. 26 is a figure showing an example of a third noisy screen state of the second liquid crystal display of this typing game apparatus according to the second embodiment;

FIG. 27 is a figure showing an example of a fourth noisy screen state of the second liquid crystal display of this typing game apparatus according to the second embodiment;

FIG. 28 is a figure showing an example of a fifth noisy screen state of the second liquid crystal display of this typing game apparatus according to the second embodiment;

FIG. 29 is a figure showing the shifting progress of the display state of a second liquid crystal display of a typing game apparatus according to a third embodiment;

FIG. 30 is a figure showing an example of a first slipped screen state of the second liquid crystal display of this typing game apparatus according to the third embodiment;

FIG. 31 is a figure showing an example of a second slipped screen state of the second liquid crystal display of this typing game apparatus according to the third embodiment;

FIG. 32 is a figure showing an example of a third slipped screen state of the second liquid crystal display of this typing game apparatus according to the third embodiment;

FIG. 33 is a figure showing an example of a fourth slipped screen state of the second liquid crystal display of this typing game apparatus according to the third embodiment; and

FIG. 34 is a figure showing an example of a fifth slipped screen state of the second liquid crystal display of this typing game apparatus according to the third embodiment.

### DESCRIPTION OF THE PREFERRED EMBODIMENTS

In the following, the typing game apparatus according to the present invention will be explained in detail with reference to the drawings, based on three concrete embodiments thereof as a housing type typing game apparatus of the sort generally set up in a game arcade. This typing game apparatus according to the embodiments below is constituted so as, along with reproducing songs via a speaker, also to display the lyrics corresponding to the song which is being reproduced in sequence on a display, and so that the player performs playing by typing the displayed lyrics in sequence on a keyboard. Moreover, the typing game which is implemented in practice consists of a plurality of stages corresponding to the number of verses in the song which is to be reproduced, and if, at the time point when one stage has been completed, the number of typing errors committed by the player is less than a predetermined number, then the game proceeds to a stage which corresponds to the next verse of the song, so that it is possible to perform the typing game continuously.

### The First Embodiment

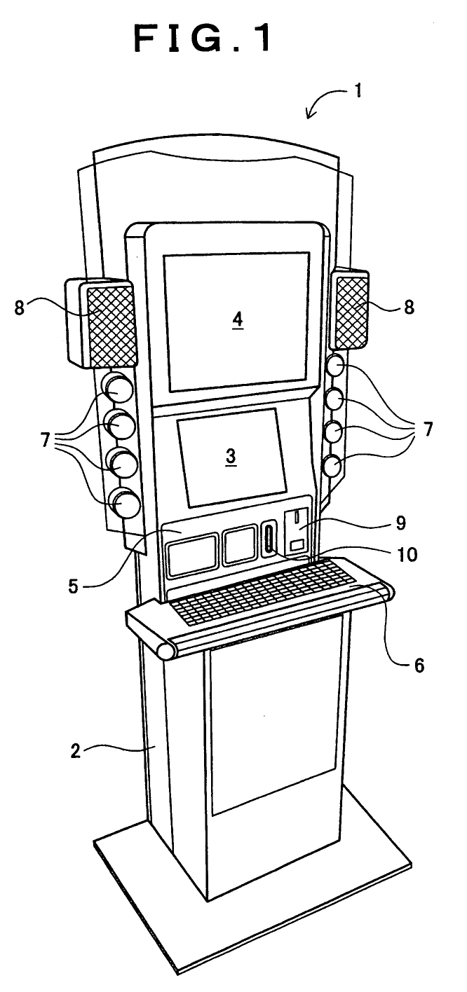

First, the overall structure of a typing game apparatus according to the first embodiment will be explained with reference to FIG. 1. FIG. 1 is a perspective view of this typing game apparatus according to the first embodiment.

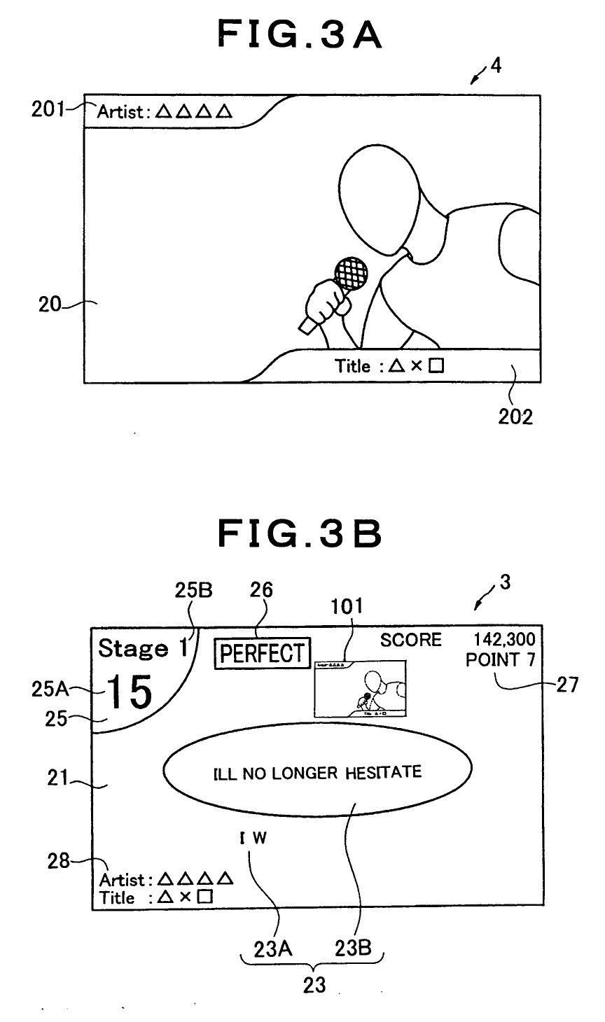

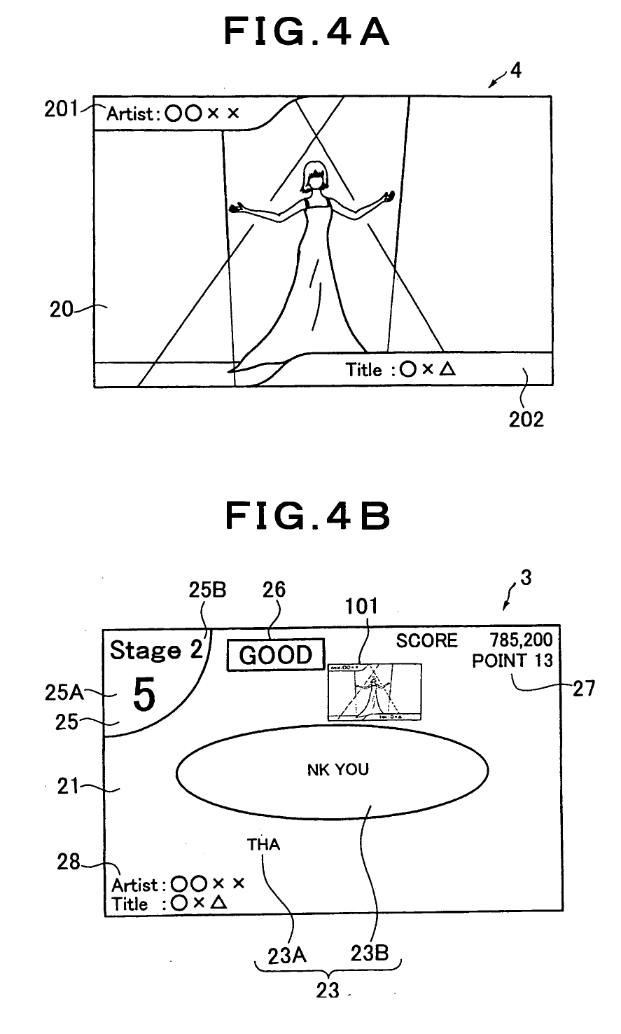

As shown in FIG. 1, the typing game apparatus according to this embodiment fundamentally comprises: a housing 2 which constitutes the outer casing of the typing game apparatus; a first liquid crystal display 3 on which a main game screen (refer to FIGS. 3B and 4B) is displayed; a second liquid crystal display 4 which is positioned above the first liquid crystal display 3, and on which images related to effects such as promotion videos or advertisements or the like (refer to FIGS. 3A and 4A) are displayed; a center panel 5 which is provided below the first liquid crystal display 3, and on which insertion slots for coins or cards are formed; a keyboard 6 on which the player performs typing; illumination lights 7 which are provided to the left and the right of the first liquid crystal display 3, and a pair of speakers 8 which are provided to the left and the right of the second liquid crystal display 4. Each of these structural elements will now be explained.

The first liquid crystal display 3 is a liquid crystal display which is provided approximately at the central portion of the front surface of the housing 2 and which is disposed at a predetermined angular inclination, and it is arranged to incline rearward from the front surface at a predetermined angle.

And display is performed (refer to FIG. 3B and FIG. 4B) on this first liquid crystal display 3 of the lyrics of a song which is being reproduced via the speakers 8 during the execution of the typing game, of the results of typing by the player, and of playing information related to the progression of the typing game (information which the player needs during the progression of the game) such as the score obtained and the like.

On the other hand, the second liquid crystal display 4 which is provided separately above the first liquid crystal display 3 is a liquid crystal display of the same type as the first liquid crystal display 3, and, during execution of a typing game, effect images related to effects for the typing game are displayed on this second liquid crystal display 4.

Here, the contents of the effect images displayed on the second liquid crystal display 4 are generally different from those which are displayed on the above described first liquid crystal display 3, and, while they are not directly required by the player to progress in the game, they have a support role in order to reach the climax of the typing game. For example although, with the typing game apparatus 1 according to this embodiment, a song by a vocalist is reproduced as the song, and the game progresses by the player performing input of the lyrics of the song via the keyboard 6, a promotion video (hereinafter abbreviated as a “PV”) related to this song is displayed on the second liquid crystal display 4 (refer to FIGS. 3A and 4A). Accordingly, it becomes possible to present the typing game in a manner with realistic sensation in which, along with the performance of the song, the artist singing the song is being displayed, so that the player does not become bored. It should be understood that the details of the displays which are displayed on the first liquid crystal display 3 and the second liquid crystal display 4 will be explained in detail hereinafter.

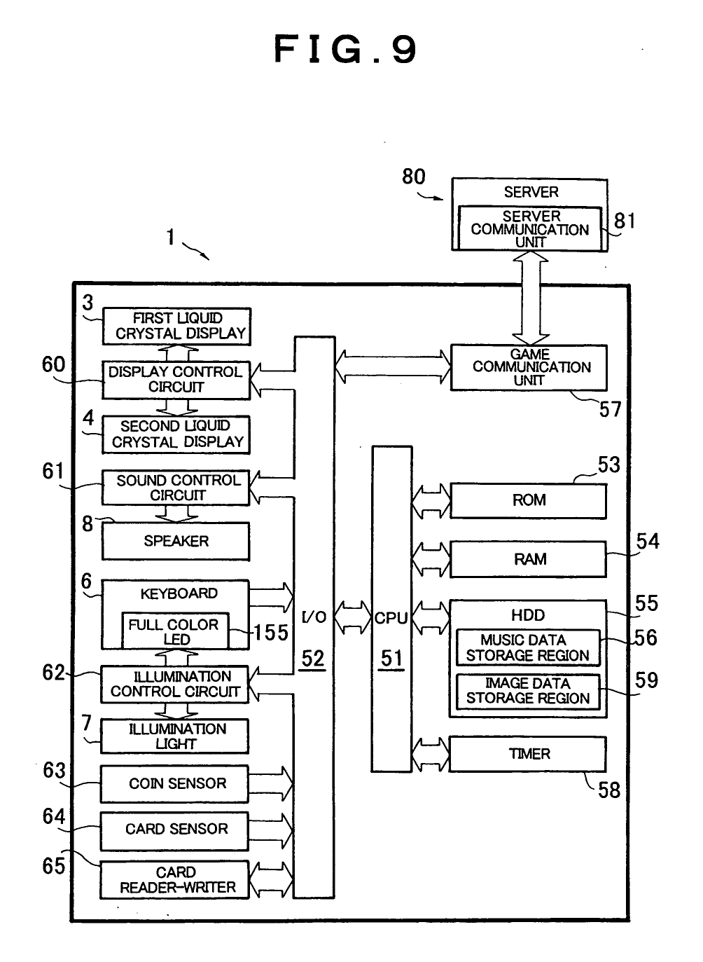

Furthermore, a coin insertion slot 9 and a card insertion slot 10 are provided on the center panel 5. The coin insertion slot 9 is an insertion slot in which a coin such as a 100 yen coin or the like is inserted. A coin sensor 63 is provided to this coin insertion slot 9, and, when a coin is inserted into the coin insertion slot 9, a coin detect signal is output via the coin sensor 63 to a CPU 51 (refer to FIG. 9), so that the CPU 51 detects that a coin has been inserted.

Furthermore, the card insertion slot 10 is an insertion slot for the insertion of an IC card (not shown in the figure) bearing an IC tag on which a game result for the typing game is recorded. In the interior of this card insertion slot 10, there are disposed a card sensor 64 and a card reader-writer 65 which will be described hereinafter (refer to FIG. 9), and, if an IC card is inserted in the card insertion slot 10, this fact is detected by the card sensor 64. Here, the IC card which is used in the typing game apparatus 1 according to this embodiment is a card which stores the game results (the score acquired and the points and so on) for the previous games of the player up to the previous one, which are kept in the incorporated IC tag, so that these stored game results can be displayed to the player by performing a predetermined operation.

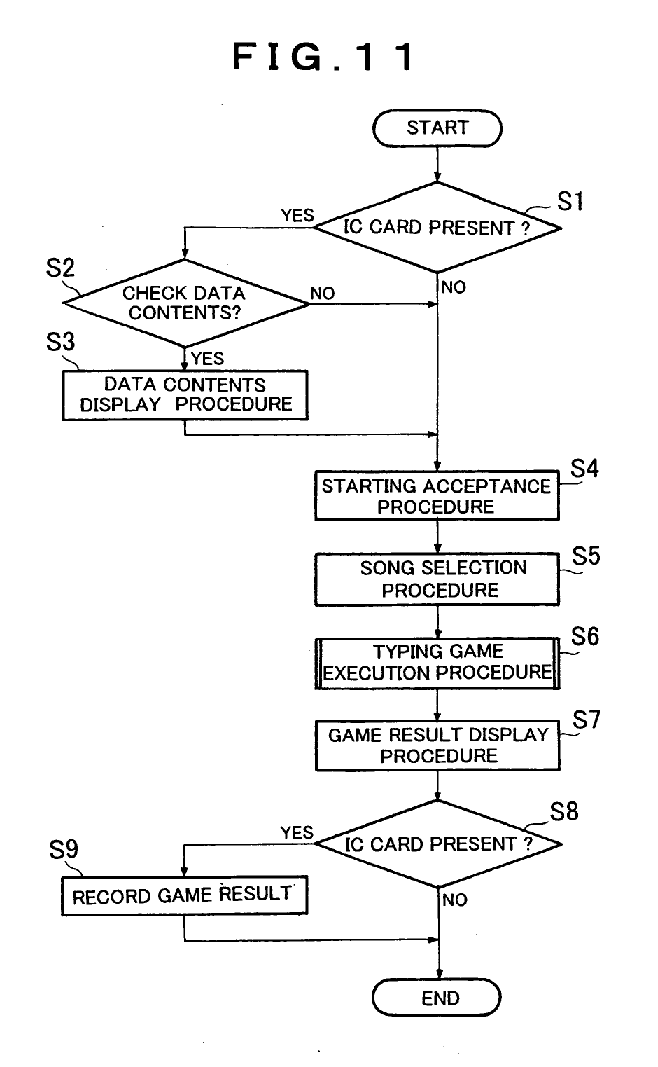

In other words, if an IC card has been detected by the card sensor 64, the card reader-writer 65 performs reading out of the results of typing games from the IC tag, and writing in of new game results to the IC tag, and the like (in steps S3 and S9 of FIG. 11).

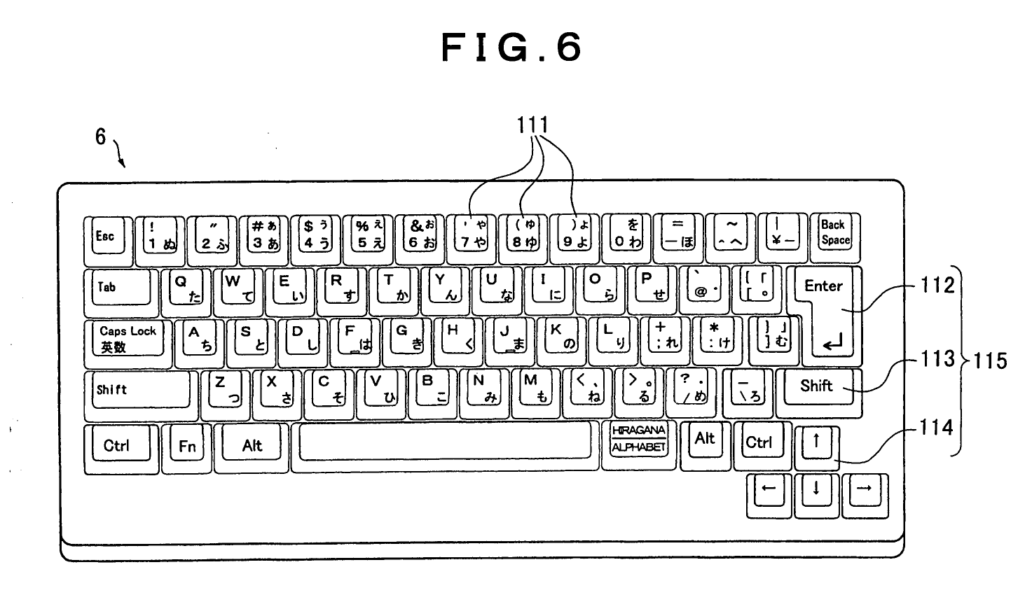

Furthermore, the keyboard 6 is a 108 key Japanese keyboard (refer to FIG. 6), which is disposed so as to project forward from the front surface of the housing 2, and on which, as will be described hereinafter, there are arranged a plurality of character input keys which perform input of Alphabet letters (A through Z), Hiragana (Japanese syllabary characters) (“a” through “n”), numerals (0 through 9), punctuation symbols (period and comma), and so on, and function keys such as an enter key, cursor keys, and so on. And, during the game, the player makes progress in the game by performing character input by typing various keys which correspond to characters, symbols, numerals, and the like, and also, before the start of play or after the end of play, based on the actuation of various keys, he performs selection of the song for which to perform the game and determination of the ease or difficulty of the game, and issue of a command to start the execution of a game and so on.

It should be understood that the structure of the keyboard will be described in detail hereinafter.

Furthermore, four illumination lights 7 are disposed on each of the left and right side surfaces of the housing 2. These illumination lights 7 are made from full color LEDs which are capable of lighting up in full color, and thereby many types of illumination effect may be provided, according to the song which is being reproduced by the typing game apparatus 1. For example, as such an illumination effect, by appropriately turning the illumination lights 7 on and off, it is possible to provide an effect of changing the illumination colors of all of the eight illumination lights 7, an effect of making changes to the illumination colors according to a fixed rule, an effect of turning the illumination lights 7 on and off, or the like.

Furthermore, speakers 8 are provided on the left and right sides of the second liquid crystal display 4. These speakers 8 are output devices which output the song which is being reproduced by the typing game apparatus 1, or effect sounds or the like. In concrete terms, during the execution of the typing game, music and voice are output at a specified tempo, based on voice data and musical accompaniment data for the song which are stored in a HDD 55 (refer to FIG. 9).

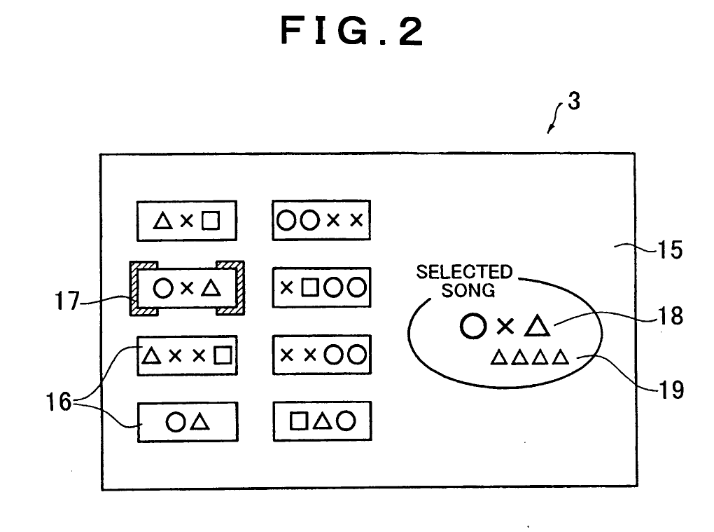

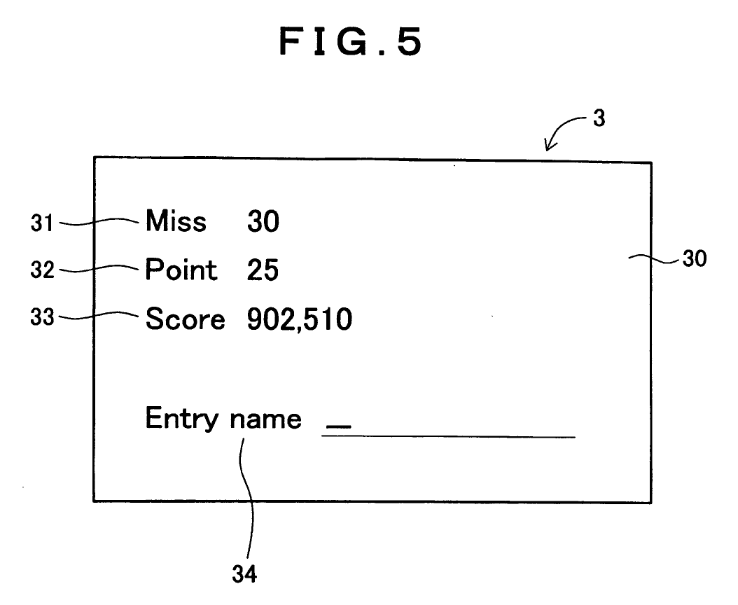

Next, the contents of the displays which are displayed on the first liquid crystal display 3 and the second liquid crystal display 4 will be explained in detail with reference to FIGS. 2 through 5. It should be understood that the contents of the displays which are displayed by the first liquid crystal display 3 and the second liquid crystal display 4 fundamentally consist of three patterns: one pattern before the start of the typing game, one pattern during the execution of the typing game, and one pattern after the end of the typing game. FIG. 2 is a schematic figure showing the details of a display which is displayed on the first liquid crystal display 3 before the start of the typing game; FIGS. 3A and 4A are schematic figures showing the details of displays which are displayed on the second liquid crystal display 4 during the typing game; FIGS. 3B and 4B are schematic figures showing the details of displays which are displayed on the first liquid crystal display 3 during the typing game; and FIG. 5 is a schematic figure showing the details of a display which is displayed on the first liquid crystal display 3 after the end of the typing game.

Thus, with the typing game apparatus 1 according to this embodiment, the typing game is performed by inputting the lyrics of a song which is being performed. In concrete terms, first, from among a plurality of songs which are made available, the player selects the song which he desires to play. And, when the typing game starts, the musical accompaniment data corresponding to the accompaniment music of the song which has been selected and the voice data corresponding to the singing voice of the artist of that song are reproduced. Moreover, along with the reproduction of the musical accompaniment data and the voice data of the song, the lyrics of the song, which are the character strings which the player must input, are displayed one phrase at a time together with the voice data which is being reproduced.

The typing game progresses by the player inputting, via the keyboard 6, the character strings which correspond to these single phrases of the lyrics which are being displayed, and, when play has terminated, based on various parameters related to the typing, such as the accuracy of the typing, the timing (strikes) at which it has been input, and the like, the results of the typing game (the number of typing errors, the score acquired, the points and so on) are calculated and are displayed. In other words, the typing game on this typing game apparatus 1 is one in which, while enjoying a song which is being performed, the player competes in the degree of skill related to typing input during the game.

First, the contents of the display before the start of the typing game will be explained with reference to FIG. 2. After insertion of a coin or coins to a predetermined monetary value into the coin insertion slot 9, before the start of the typing game, as shown in FIG. 2, a song selection screen 15 which shows a list of songs which can be played with this typing game apparatus 1 is displayed on the first liquid crystal display 3.

This song selection screen 15 comprises playable song display sections 16 in which the names of songs which can be played are displayed, a song selection cursor 17 with which any one of the playable song display sections 16 may be selected, a selected song name display section 18 in which is displayed the name of the song which is being selected by the song selection cursor 17, and a selected artist name display section 19 in which is displayed the name of the artist of the song which is being selected by the song selection cursor 17.

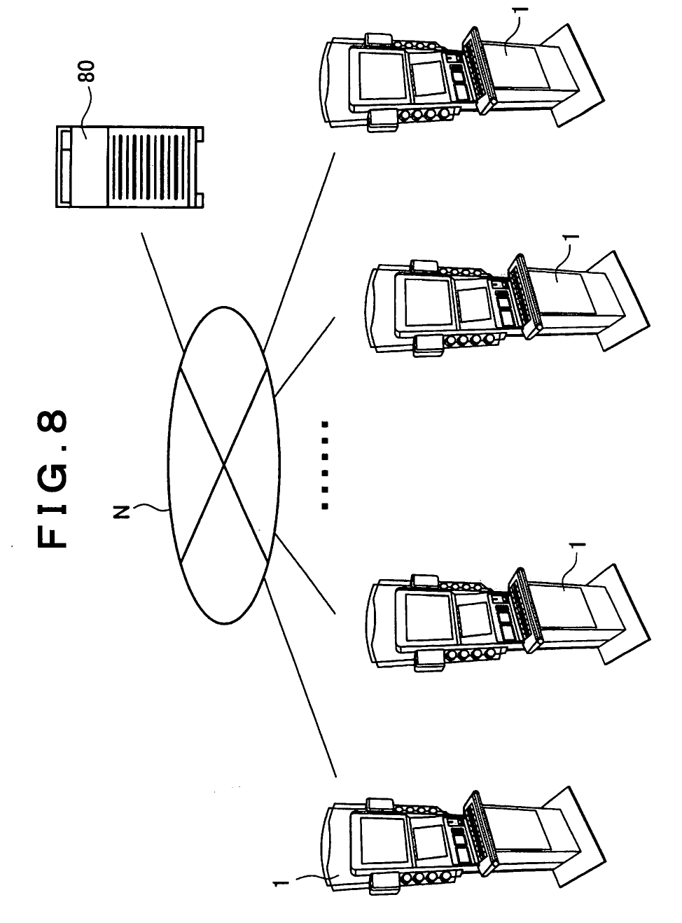

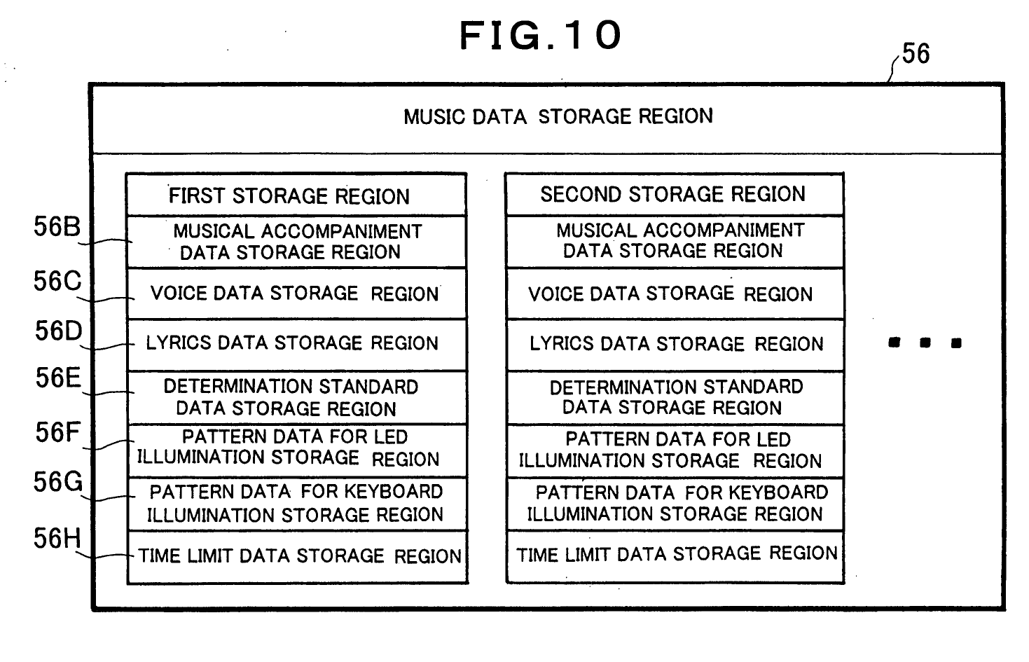

The playable song display sections 16 are fields each of which shows the name of a song which can be played by the typing game apparatus 1 at the current time (in this embodiment, a maximum of eight names). Here, by the songs which are displayed by the playable song display sections 16 and can be played, are meant songs for which the music data is stored on the HDD 55 which will be described hereinafter (refer to FIG. 9 and FIG. 10), and for which, additionally, the music data which is stored is managed by a server 80 (refer to FIG. 8) and is updated in due order. Accordingly, the player is enabled to select and to play any song from among a plurality of songs, including the most up to date songs, which are updated by the server 80. It should be understood that it may be arranged to display, in the playable song display sections 16, not only names of the songs, but also photographs of the artists or PVs.

Furthermore, the song selection cursor 17 can be shifted up, down, left, and right over the playable song display sections 16 by actuation of cursor keys 114 on the keyboard 6 (refer to FIG. 6), and the name of the song of that playable song display section 16 at which the song selection cursor 17 is currently positioned, and the name of its artist, are displayed in the selected song name display section 18 and the selected artist name display section 19.

And, when the enter key 112 (refer to FIG. 6) is pressed down in the state in which the song selection cursor 17 has been positioned above that one of the playable song display sections 16 in which the name of the desired song is displayed, the song which is to be played is determined on, and the typing game starts.

It should be understood that, while the song selection screen 15 is being displayed on the first liquid crystal display 3, a PV of any desired song may be running on the second liquid crystal display 4. Furthermore, an image of an advertisement or the like may also be displayed. Yet further, it may be arranged to display the song selection screen 15, not on the first liquid crystal display 3, but rather on the second liquid crystal display 4.

Next, the contents of displays provided during the execution of the typing game will be explained with reference to FIGS. 3 and 4. FIG. 3A and FIG. 3B are figures respectively showing the display contents of the first liquid crystal display 3 and the second liquid crystal display 4 when a predetermined song A by a male artist has been selected on the song selection screen 15 and the typing game has started, while FIG. 4A and FIG. 4B relate to the case when a predetermined song B by a female artist has been selected on the song selection screen 15 and the typing game has started.

As shown in FIG. 3A, when for example the song A has been selected and the game has started, an image 20 of a PV of the male artist who sings the song A is displayed on the second liquid crystal display 4 while being performed via the speakers 8. On the other hand, as shown in FIG. 4A, when for example the song B has been selected and the game has started, an image 20 of a PV of the female artist who sings the song B is displayed on the second liquid crystal display 4 while being performed via the speakers 8.

On the other hand, as shown in FIGS. 3B and 4B, in parallel with the display of the image 20 of the PV on the second liquid crystal display 4, a main game screen 21 which is related to the progression of the typing game is displayed on the first liquid crystal display 3.

Here, this main game screen 21 is made up from: a lyrics display section 23 which displays the lyrics of the phrase which is currently being performed; a song state display section 25 which displays to which number verse (i.e. to which stage), and moreover to which number phrase, counting from when this verse started, the phrase of the lyrics which is currently being displayed in the lyrics display section 23 corresponds; a typing result display section 26 which displays the results of determination of errors in the typing by the player; an acquired score display section 27 which displays the score which the player has acquired up until the present moment and his points and the like; a song information display section 28 in which the name of the artist and the name of the song which are currently being performed are displayed; and the like.

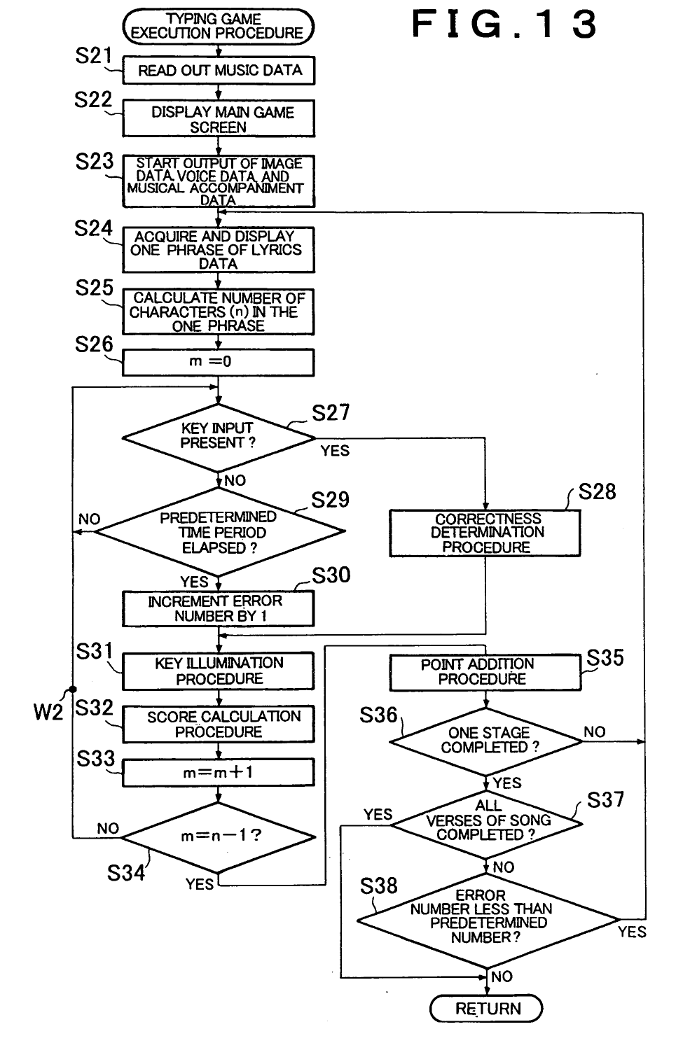

The lyrics display section 23 is a display section on which is displayed a single phrase of the lyrics of the song which is currently being performed, and the game progresses by the player typing the lyrics which are being displayed in this lyrics display section 23 on the keyboard 6. And if the player types the lyrics which are being displayed correctly the score steadily add up, whereas if he has input the lyrics incorrectly, no score are added, but rather the number of errors is increased by the number of input errors which he has committed. If within any verse (stage) making up the song, or when any verse finishes, this number of typing errors reaches or exceeds a predetermined number, then the game terminates at that time point (refer to S38 of FIG. 13).

Furthermore, the characters which have been typed up until now may be notified to the player by displaying, among the shown lyrics, that character string 23A which has already been typed by the player as shifted down into the next line, as compared with the character string 23B before typing.

Further, the song state display section 25 displays in which verse is the phrase of the lyrics which is currently being displayed on the lyrics display section 23, and moreover to which number phrase it corresponds, counting from when the verse started. Here, the typing game according to this embodiment consists of a plurality of stages (for example, it may consist of first through third stages) corresponding to the number of verses in the song which is being reproduced (for example, one song may be made up from 1 to 3 verses). For example, in FIG. 3B, it is shown that the fifteenth phrase of stage 1 (i.e. verse 1) is currently being displayed. Furthermore, in FIG. 4B, it is shown that the fifth phrase of stage 2 (verse 2) is being displayed.

And, each time the input of a single phrase is completed by the player, the numerical value 25A which indicates the number of this phrase is incremented by 1; and, each time the input during a single stage is completed, the numerical value 25B which indicates the stage number (the verse number) of this stage is incremented by 1. By doing this, it becomes possible to notify to the player the stage number (the verse number) at the present time, and the number of phrases for which typing has been completed up until the present time.

The typing result display section 26 is a display section which displays the results of error determination of the typing by the player, and “PERFECT” is displayed when the correct characters have been typed (struck) at the same timing corresponding to the vocals of the song which is being performed. Furthermore, “GOOD” is displayed when the correct characters have been typed at a timing which is different from that of the vocals of the song which is being performed. On the other hand, “MISS” is displayed when the wrong characters have been typed, irrespective of their timing.

The acquired score display section 27 is a display section which displays the score and the points which have been acquired by the player up till now. Here, the score is added to by typing correctly according to the character strings which are displayed in the lyrics display section 23, and moreover the score is also added to if the corresponding characters have been typed (struck) at the same timing as the vocals of the song which is being performed. On the other hand, the points are added to one point at a time (S35 of FIG. 13), if the text for one phrase has been input without making any typing errors.

And this score and these points are added up until the game is completed, and then, when the game ends, if an IC card has been inserted into the card insertion slot of the center panel 5, this score and these points which have been acquired are stored on that IC card.

Furthermore, the name of the song selected by the player at the start of the game, which is currently being performed, and the name of its artist, are both displayed in the song information display section 28.

Moreover, in the main game screen 21 of the first liquid crystal display 3, as shown in FIG. 3B and FIG. 4B, an independent image region 101 is provided at its central upper portion. It should be noted that this independent image region 101 is not provided within the main game screen 21 as overlapping the lyrics display section 23, the song state display section 25, the typing result display section 26, the acquired score display section 27, and the song information display section 28. And the image in this independent image region 101 is displayed at the same timing as that of the image 20 of the PV which is being displayed on the second liquid crystal display 4.

It should be understood that, as shown in FIG. 3A and FIG. 4A, an artist name information display section 201, in which the name of the artist who is currently being performed is displayed, is provided at the upper left edge portion of the second liquid crystal display 4 on which the image 20 of the PV is being displayed; and a song name information display section 202, in which the name of the song which is currently being performed is displayed, is provided at the lower right edge portion of the second liquid crystal display 4 on which the image 20 of the PV is being displayed. Furthermore, here, as shown in FIG. 3B and FIG. 4B, the name of the artist and the name of the song are both displayed at the left upper edge portion and the right lower edge portion of the independent image region 101 of the main game screen 21 on the first liquid crystal display 3 as well.

It should be noted that, at the upper edge portion and the lower edge portion of the independent image region 101, other than the name of the artist and the name of the song, it would also be acceptable to display the phrase number of the song which is currently being performed, the number of the stage (verse), and/or the score and the points and the like which the player has acquired up to now; or conversely, it would also be acceptable not to display anything there.

Furthermore although, in this embodiment, it is arranged to display the main game screen 21 on the first liquid crystal display 3, and to display the image 20 of the PV on the second liquid crystal display 4, it would also be acceptable, in the opposite manner, to arrange to display the image 20 of the PV on the first liquid crystal display 3, and to display the main game screen 21 on the second liquid crystal display 4.

Furthermore, in this case, the independent image region 101 would be provided in the central upper portion of the main screen 21 which is being displayed on the second liquid crystal display 4, and the image 20 of the PV which is being displayed on the first liquid crystal display 3 would be displayed at the same timing in this independent image region 101.

And, as shown in FIG. 5, after the typing game has terminated, a game result display screen 30 which shows the result of this current typing game is displayed on the first liquid crystal display 3.

This game result screen 30 includes an error number display section 31 on which the number of errors typed during the current typing game is displayed, an acquired point display section 32 on which the number of points acquired is displayed, an acquired score display section 33 on which the score acquired is displayed, and a name input display section 34 which invites input of the name of the player who has been playing.

And, by referring to this game result screen 30, the player is able to recognize each of the number of errors in the current typing game, the points which he has acquired, and the score which he has acquired. Furthermore, by inputting any desired name into the name input display section 34 by using the keyboard 6, he is able to record the score which he has acquired in a ranking list. A list of the rankings which have been recorded is displayed on the first liquid crystal display 3 or the second liquid crystal display 4 during a demo screen or the like.

It should be understood that the lyrics of the song which was used during play may be replayed on the second liquid crystal display 4 while the game result screen 30 is being displayed on the first liquid crystal display 3, and moreover the spots at which correct input was not possible may be displayed with an underline or the like, the display may be scrolled in the upwards direction, or a PV for any desired song may be played, or the like. Furthermore, images of advertisements or the like may be displayed. Furthermore, the game result screen 30 may also be displayed, not on the first liquid crystal display 3, but instead on the second liquid crystal display 4.

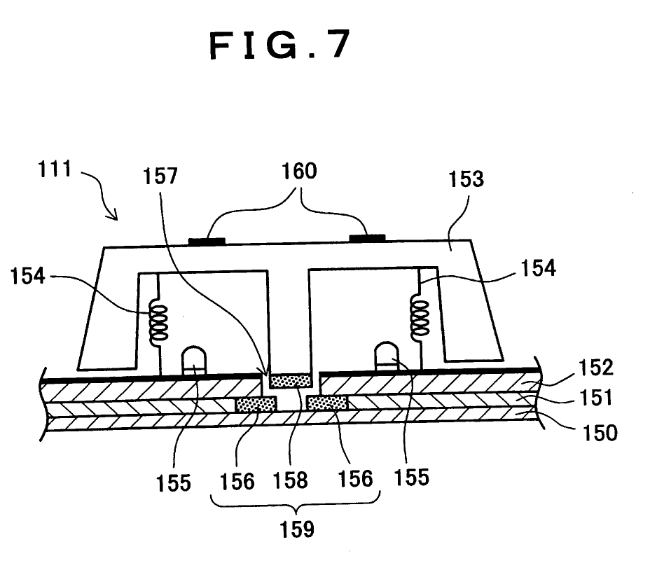

Next, the keyboard 6 which is provided to this typing game apparatus 1 will be explained with reference to FIG. 6 and FIG. 7. FIG. 6 is a plan view showing the keyboard which is provided to the typing game apparatus according to this embodiment. And FIG. 7 is a schematic sectional view showing, in cross section, one of a plurality of keys which are provided to this keyboard.

As shown in FIG. 6, the keyboard 6 is a Japanese 108 key keyboard on which there are arrayed a plurality of character input keys 111 which perform input of Alphabet letters (A through Z), Hiragana (Japanese syllabary characters) (“a” through “n”), numerals (0 through 9), punctuation symbols (period and comma) and the like, and various function keys 115 such as an enter key 112, a shift key 113, cursor keys 114 and the like. And, during play, the player progresses through the game by performing character input by typing the character input keys 111 corresponding to characters, punctuation symbols, numerals and the like, and, before the start of play and after the end of play, based on actuation of the function keys 115, he issues commands to determine on the songs with which to perform the game, to select a level of difficulty for the game, to start the execution of the game, and the like. Furthermore, illumination LEDS are provided in the interiors of various keys on the keyboard 6, so that, based on control signals from the CPU 51, the keys may be illuminated in various ways.

Now, the structure of the interiors of the keys of the keyboard 6 will be explained based on FIG. 7. It should be understood that all of the plurality of keys which are arranged on the keyboard 6 have similar interior structures. Accordingly, in the following, the interior construction of one of the character input keys 111 which are arranged on the keyboard 6 will be explained by way of example, and explanation of the structure of the other character input keys 111, and of the function keys 115, will be curtailed.

As shown in FIG. 7, this character input key 111 fundamentally comprises a base plate 150, a switch circuit board 151, a light emitting circuit board 152, a keytop 153, biasing mechanisms 154, full color LEDs 155, and the like.

In particular, on the switch circuit board 151 which is laid over the base plate 150, there are provided a pair of electrodes 156 which are disposed directly underneath the vicinity of the center of the keytop 153.

Furthermore, an opening portion 157 for exposing the above described pair of electrodes 156 is provided on the illumination circuit board 152 which is laid over the switch circuit board 151, and full color LEDs 155, which can be illuminated in full color, are provided around the circumference of this opening portion 157.

Moreover, the biasing mechanisms 154 are provided between the illumination circuit board 152 and the keytop 153, and the keytop 153 is returned to the opposite side against the switch circuit board 151 by these biasing mechanisms 154. Furthermore, an electrode 158 is provided in the vicinity of the center of the keytop 153, so as to project towards the switch circuit board 151. Accordingly since, when the keytop 153 is actuated by being pressed downwards, the electrode 158 which is provided so as to project from the keytop 153 is able to contact against the pair of electrodes 156 which are provided on the switch circuit board 151, therefore the fact that the keytop 153 has been actuated by being depressed can be transmitted as an electrical signal which flows in the switch circuit board 151. In other words, a key switch 159 is constituted by these three electrodes 156 and 158.

It should be understood that the biasing mechanisms 154 may be made as simple elastic bodies, or may be made as elastic bodies with linking mechanisms; they may be of any appropriate structure.

Furthermore, the keytop 153 may be made from any material which has the property of being translucent (for example, from translucent acrylic or translucent plastic or the like), and key information 160 such as a character, a numeral, a symbol or the like may be printed on its planar top surface in black color. Moreover, the surface of the illumination circuit board 152 towards the keytop 153 may also be printed in black color.

Accordingly, when the full color LEDs 155 are turned off, the translucent keytop 153 appears in black color, which is the color of the surface of the illumination circuit board 152, so that it becomes difficult to recognize the key information 160 which is printed in black color, against this keytop 153 which appears in the same black color.

On the other hand since, when the full color LEDs 155 are turned on, the translucent keytop 153 appears in the color in which the full color LEDs 155 are illuminated, accordingly it becomes easy to recognize the key information 160 which is printed in black color, on the keytop 153 which appears in this color.

And, in the keyboard 6, the various key switches 159 in the interiors of the keys are connected to a signal generation circuit not shown in the figures. This signal generation circuit is connected to the CPU 51 of the typing game apparatus 1 via an interface unit 52 (subsequently termed an I/O) which will be described hereinafter. Accordingly, by transmitting an electrical signal from the key switch 159 of the key which has been actuated by pressing via this signal generation circuit to the CPU 51, it is possible to specify the type of the key which has been actuated by being pressed. It should be understood that the signal generation circuit is mounted on the above described switch circuit board 151.

Furthermore, in the keyboard 6, the full color LEDs 155 interior to the keys are connected to an illumination control circuit 62. Moreover, the illumination control circuit 62 is connected via the I/O 52 to the CPU 51 (refer to FIG. 9). Accordingly, via this illumination control circuit 62, it is possible to turn these full color LEDs 155 interior to the keys on according to the colors which have been specified by the CPU 51. In concrete terms, with this typing game apparatus 1 according to this embodiment, during the typing game, if it has been determined that key input has occurred, and moreover that correct typing has been performed, then the character input key 111 which has been depressed is illuminated in blue color. Furthermore, if it has been determined that key input has occurred, but that incorrect typing has been performed, then the character input key 111 which has been depressed is illuminated in red color, while the correct key which should have been input is illuminated in green color. Moreover, if no key input has taken place, then only the correct key which should have been input is illuminated in green color.

It should be understood that, as shown in FIG. 8, the typing game apparatus 1 according to this embodiment is connected to a server 80 via a network N, such as the internet or the like, which is capable of bidirectional communication. And, based on data transmitted from the server 80, the music data stored on the HDD 55 (refer to FIG. 9) of the typing game apparatus 1 can be updated.

Accordingly it is made possible, by updating the music data, to change the type of songs which can be played by the typing game apparatus 1, and furthermore, by managing several typing game apparatuses which are set up in several game arcades all together, this data updating task becomes simple and easy.

Next, structures related to the control system for this typing game apparatus 1 will be explained based on FIG. 9. FIG. 9 is a schematic block diagram showing the control system for the typing game apparatus according to this embodiment.

As shown in FIG. 9, the control system for the typing game apparatus 1 comprises a CPU 51 which oversees the various types of control for the typing game apparatus 1 such as play processing operation and the like, a ROM 53 and a RAM 54 which are connected to the CPU 51, and peripheral devices (actuators) which are electrically connected to this CPU 51 and the like.

The CPU 51 is a central calculation processing device which performs calculation processing according to various types of commands. The I/O 52 is a connection unit which directly and/or indirectly electrically connects together the first liquid crystal display 3, the second liquid crystal display 4, the keyboard 6, the illumination lights 7, the speakers 8, and so on with the CPU 51.

The ROM 53 is a dedicated non-volatile read out only memory, in which is stored a calculation program for the operation of a flow chart which will be described hereinafter.

Furthermore, the RAM 54 is a memory which temporarily stores various types of data which have been calculated by the CPU 51, and it stores the number of typing errors made by the player during the typing game, the score which he has acquired, the points which he has acquired, and so on. Furthermore, the lyrics data of that music data which, among the plurality of music data stored on a HDD 55 which will be described hereinafter, are being used in the current typing game, are temporarily stored in the RAM 54, divided up into single phrases.

The HDD 55 is a storage device on which are stored image data and music data used during the execution of the typing game by the typing game apparatus 1. Here, the image data are stored in individual storage regions of an image data storage region 59 which is formed on the HDD 55. Furthermore, the music data consists of musical accompaniment data, voice data, lyrics data, determination standard data, pattern data for LED illumination, pattern data for keyboard illumination, and time limit data, and they are stored in individual storage regions of a music data storage region 56 which is formed on the HDD 55 (refer to FIG. 10).

Yet further, in the music data storage region 56, there are stored the data for the music data for a plurality of songs (in this embodiment, for a maximum of eight songs), and these music data items which are stored are updated as required, based on data transmitted from the server 80 as described above. And the types of song names displayed on the song selection screen 15 (refer to FIG. 2) change based on the types of music data stored in the music data storage region 56, and the typing game is performed based on the music data corresponding to the song which has been selected on the song selection screen 15 (refer to FIG. 3 and FIG. 4).

Moreover, in relation to the music data, in the same manner for the image data, there are stored in the image data storage region 59, the data for a plurality of songs (in this embodiment, for a maximum of eight songs), and these image data items which are stored are updated as required, based on data transmitted from the server 80 as described above.

It should be understood that, here, in the image data storage region 59 which is formed on the HDD 55, among the abovementioned music data, there are stored image data relating to an image 20 of a PV of the artist, which is being displayed at the same timing on the independent image region 101 of the main game screen 21 of the first liquid crystal display 3 and on the second liquid crystal display 4 (refer to FIG. 3A and FIG. 4A).

Now, the music data storage region 56 formed on the HDD 55 will be explained in detail with reference to FIG. 10. FIG. 10 is a schematic explanatory figure showing this music data storage region 56.

As shown in FIG. 10, the music data storage region 56 of the typing game apparatus 1 according to this embodiment comprises a plurality of storage regions (in this embodiment, a first through an eighth storage region) which correspond to the number of items of music data which can be stored (in this embodiment, eight songs); and, in each of these storage regions, there are provided a musical accompaniment data storage region 56B, a voice data storage region 56C, a lyrics data storage region 56D, a determination standard data storage region 56E, a pattern data for LED illumination storage region 56F, a pattern data for keyboard illumination storage region 56G, and a time limit data storage region 56H.

To explain each of these storage regions in the following, the musical accompaniment data storage region 56B is a storage region in which are stored musical accompaniment data among the music data, related to accompaniment by musical instruments or the like, and output from the speakers 8.

Furthermore, the voice data storage region 56C is a storage region in which are stored voice data among the music data, related to the singing voice of the artist who is singing, and output from the speakers 8.

Moreover, the lyrics data storage region 56D is a storage region in which are stored lyrics data among the music data, related to the text data of the lyrics of the song. And, as described above, during the execution of the typing game, these lyrics are displayed on the first liquid crystal display 3 one phrase at a time (refer to FIG. 3B and FIG. 4B).

And the determination standard data storage region 56E is a storage region in which are stored determination standard data among the music data, related, during the execution of the typing game, to determination of the correctness of the characters which the player has typed, and to a standard for determining the correctness of his input timing. And the CPU 51 adds to the error number, the score, the points and so on, based on this stored determination standard data and the operation signal from the keyboard 6, as will be described hereinafter.

Yet further, the pattern data for LED illumination storage region 56F and the pattern data for keyboard illumination storage region 56G are storage regions in which are respectively stored, among the music data, pattern data for LED illumination for illuminating the illumination lights 7, and pattern data for keyboard illumination for illuminating the full color LEDs 155 which are provided in the interiors of the keys. With the typing game apparatus 1 according to this embodiment, during the execution of the typing game, the state of illumination of each of the eight illumination lights 7 (its illumination color, and whether it is turned on or off) is controlled by an illumination control circuit 62 which will be described hereinafter, based on the stored pattern data for LED illumination. Furthermore, during the execution of the typing game, the state of illumination of each of the full color LEDs 155 provided in the interiors of the keys (its illumination color, and whether it is turned on or off) is controlled by the illumination control circuit 62 which will be described hereinafter, based on the stored pattern data for keyboard illumination. It should be understood that, as illumination patterns for the full color LEDs 155, there may be utilized a pattern of illumination which assists key input for a novice at the typing game by turning on in order the keys which must be input with illumination colors which are different from the illumination color of the keyboard 6 as a whole, or a pattern in which the illumination colors of all of the keys which are disposed on the keyboard 6 are varied along with the image for the song.

Still further, the time limit data storage region 56H is a storage region in which are stored, among the music data, time limit data related to a time limit over which the music data may be used. This time limit data comprises two items of date data: a day when the music data becomes usable (a usage start day); and a day when the music data becomes unusable (a usage end day). This time limit data is utilized along with a timer 58 (refer to FIG. 9) in the management of time limits for use of the music data; and the timing game is controlled by the CPU 51 so that the typing game cannot be played using music data whose time limit for use has been exceeded.

Now, returning to FIG. 9, the explanation of the control system of the typing game apparatus 1 will be continued.

A game communication unit 57 is a device which, along with converting a signal which is output by the typing game apparatus 1 into a signal of a format which can be transmitted according to a communication method such as a telephone line or a LAN cable or the like, and transmitting it to the server 80, also receives a signal which has been transmitted from the server 80, and re-converts it into a signal of a format capable of being read in by the typing game apparatus 1; and it is connected to a server communication unit 81 of the server 80 via the network N, such as the internet or the like, which is capable of bidirectional communication (refer to FIG. 8).

Moreover, a timer 58 is connected to the CPU 51. The information from this timer 58 is transmitted to the CPU 51, and the CPU 51 performs management of the usage time limit for music data which has been stored, from the information of the timer 58 and the time limit data which is stored in the time limit data storage region 56H of the HDD 55.

Furthermore, a display control circuit 60 is a section which is connected via the I/O 52 to the CPU 51, and which controls the display contents of the first liquid crystal display 3 and the second liquid crystal display 4 according to the results of calculation processing by the CPU 51. Here, this display control circuit 60 comprises a program ROM, an image ROM, an image control CPU, a work RAM, a VDP (Video Display Processor), a video RAM, and the like. And, in the program ROM, there are stored a program for image control and various types of selection table related to display on the first liquid crystal 3 and the second liquid crystal display 4. In particular, the independent image region 101 is provided at the upper central portion of the main game screen 21 on the first liquid crystal display 4, and there are stored a program for image control and various types of selection table which are required when displaying the image 20 of the PV at the same timing in this independent image region 101 and on the second liquid crystal display 4. Furthermore, there are stored in the image ROM, for example, dot data for forming images which are displayed on the first liquid crystal display 3, such as the song selection screen 15 (refer to FIG. 2) and the main game screen 21 (refer to FIGS. 3 and 4) and so on.

And the image control CPU performs determination, from among the dot data which has been stored in advance in the image ROM, of the images to display on the first liquid crystal display 3 and on the second liquid crystal display 4, according to an image control program which has been stored in advance in the program ROM, based on parameters which have been set by the CPU 51. Moreover, the VDP forms images according to the display contents which have been determined on by the image control CPU, and outputs them to the first liquid crystal display 3 and to the second liquid crystal display 4.

By doing this, for example, during the standby state, a demo screen which consists of a PV for any desired song, an advertisement, a list of rankings or the like may be displayed, and furthermore, after a coin has been inserted into the coin insertion slot 9, the song selection screen 15 (refer to FIG. 2) is displayed on the first liquid crystal display 3. And, when the execution of the typing game on the typing game apparatus 1 has been started, along with displaying the lyrics data included in the music data one phrase at a time on the first liquid crystal display 3, control and so on is performed for comparing the character string 23A which has already been typed by the player based on the input results from the keyboard 6 with the character string 23B before typing, and shifting it downward. On the other hand, the PV, which is separate image data from the music data, is displayed on the second liquid crystal display 4. And, moreover, on the first liquid crystal display 4, the independent image region 101 is provided at the central upper portion of the main game screen 21, and this PV is displayed at the same timing in this independent image region 101 and on the second liquid crystal display 4.

A sound control circuit 61, along with being connected via the I/O 52 to the CPU 51, is also connected to the speakers 8. And, when the typing game is executed and the music data which has been stored in the music data storage region 56 of the HDD 55 is read out, the musical accompaniment data and the voice data which are included in this music data are converted into a sound signal by this sound control circuit 61, and are output by the speakers 8.

And an illumination control circuit 62, along with being connected via the I/O 52 to the CPU 51, is also connected to the illumination lights 7 and to the full color LEDs 155 (refer to FIG. 7) which are disposed in the interiors of the keys. When the music data which is stored in the music data storage region 56 of the HDD 55 is read out by the CPU 51, this illumination control circuit 62 controls the states of illumination of the illumination lights 7 and of the full color LEDs 155, based on the pattern data for LED illumination and on the pattern data for keyboard illumination which are included in this music data.

Furthermore, the keyboard 6 is connected to the CPU 51. When the keytops 153 are actuated by being pressed down, the key switches 159 which are provided in the interiors of the keys of the keyboard 6 transmit electrical signals which pass through the switch circuit board 151. The CPU 51 controls the various types of operation which are to be executed corresponding to the various keys, based on the switch signals which are output from the various key switches 159 due to the various keys being pressed down.

A coin sensor 63 is a sensor which detects a coin (for example a 100 yen coin) which is used as payment for performing the typing game on this typing game apparatus 1. This coin sensor 63 is provided in the interior of the coin insertion slot 9, and is connected via the I/O 52 to the CPU 51. Accordingly, based on insertion of a coin into the coin insertion slot 9, the coin sensor 63 sends a coin inserted signal to the CPU 51. And the CPU 51 makes it possible to execute the typing game, when it has detected coin insertion signals corresponding to a predetermined game fee (for example 200 yen).

Moreover, a card sensor 64 is a sensor which detects whether or not an IC card is inserted into the card insertion slot 10, and a card reader-writer 65 is a device for performing reading out and writing in of data to and from an IC tag which is provided on such an IC card. The card sensor 64 and the card reader-writer 65 are both provided in the interior of the card insertion slot 10, and are connected via the I/O 52 to the CPU 51. And, if an IC card has been detected by the card sensor 64, on performance of a predetermined operation, the game result of the typing game is read out from the IC tag by the card reader-writer 65 (S3 of FIG. 11). Moreover, at the end of the typing game, it performs writing into the IC tag (S9 of FIG. 11) of the new game result (i.e of the score and the points which have been acquired).

Next, a main processing program which is performed by this typing game apparatus 1 structured as above will be explained with reference to FIG. 11. FIG. 11 is a flow chart showing the main processing program of the typing game apparatus according to this embodiment. It should be understood that each of the programs shown in the flow charts of FIGS. 11 through 13 below is stored in the ROM 53 or the RAM 54 which is provided to the typing game apparatus 1, and is executed by the CPU 51.

As shown in FIG. 11, first, in a step S1, based on the detection signal from the card senor 64, the CPU 51 determines whether or not an IC card is inserted into the card insertion slot 10. And, if it has determined that an IC card is inserted (S1: YES), then in a step S2 it is further determined whether or not a check request from the player for the data contents has been received. On the other hand, if it has been determined that no IC card is inserted (S1: NO), then the flow of control proceeds to a step S4.

Thus, with the typing game apparatus 1 according to this embodiment, when, in the state before insertion of a coin and also with an IC card possessed by the player having been inserted into the card insertion slot 10, the shift key 113 on the keyboard 6 is pressed down, a list of the game results which have been recorded on the IC card (the score and points and so on which the player has acquired in previous games) is displayed on the first liquid crystal display 3, so that it becomes possible for the player to check its contents.

Accordingly, in the determination of the step S2 it is determined, based on the operation signal from the keyboard 6, whether or not the shift key 113 has been pressed down, and if it has been determined that the shift key 113 has been pressed down (S2: YES), then the data on the IC tag which is mounted on the IC card is read out by the card reader-writer 65, and, based on this read out data, a list of game results is displayed (in a step S3) on the first liquid crystal display 3.

Furthermore, in the step S4, a starting acceptance procedure is performed. In concrete terms, in this starting acceptance procedure, it is determined whether or not coins (100 yen coins or the like) have been inserted into the coin insertion slot 9 to a predetermined monetary amount (in this embodiment, to the amount of 200 yen), and the system waits in a standby state, until such a number of coins are thus inserted, while displaying on the display a demo screen or the like consisting of a demo play game screen, a PV of some desired song, an advertisement, a list of ranking data, or the like. It should be understood that, with the typing game apparatus 1 according to this embodiment, when a coin is inserted into the coin insertion slot 9, it is detected by the coin sensor 63, which outputs a coin detect signal to the CPU 51. Due to this, it is possible for the CPU 51 to determine that a coin has been inserted by the player.

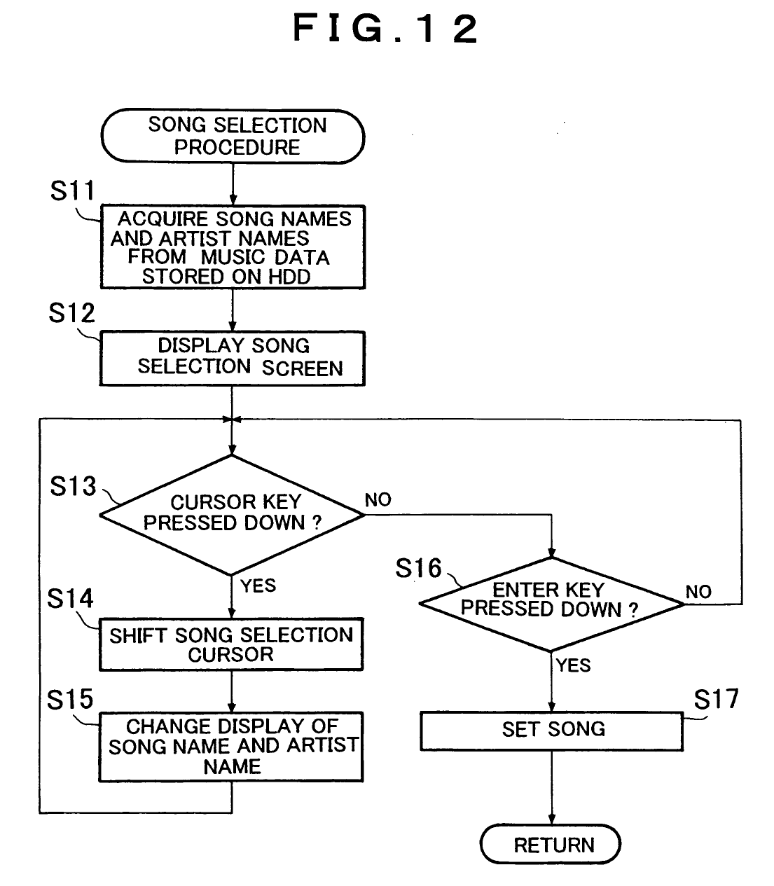

Next, in a step S5, a song selection procedure shown in FIG. 12 is performed. In this song selection procedure, based on the type of music data which is stored in the music data storage region 56 of the HDD 55 as will be described hereinafter, the song selection screen 15 (refer to FIG. 2) is displayed on the first liquid crystal display 3, and the song which is to be used in the present game is set.

And, in a step S6, a typing game execution procedure shown in FIG. 13 is performed, based on the song which was set in the step S5. In this typing game execution procedure, along with providing performance of the song as will be described hereinafter, the score and the points are added up based on the results of typing on the keyboard 6, and this is continued until a predetermined termination condition is satisfied.

Thereafter, when the typing game execution procedure is terminated, a game result display procedure is performed (in a step S7). In concrete terms, in this game result display procedure, the game result screen 30 (refer to FIG. 5) is displayed on the first liquid crystal display 3, based on the results of the typing game in the step S6. In this game result screen 30, the number of errors, the points which have been acquired, and the score which has been acquired during this typing game, which have been stored in the RAM 54, are each displayed, and moreover a name input display section 34 is displayed and input is solicited of the name of the player who was playing. Furthermore, when in this state the keyboard 6 is actuated, based on the actuation signals, the characters which are input to the name input display section 34 are displayed. And, if the score which has been acquired is greater than or equal to a predetermined score, then the ranking data which is stored in the RAM 54 is updated.

Next, in a step S8, the CPU 51 determines whether or not an IC card is inserted into the card insertion slot 10, based on the detection signal from the card sensor 64. And, if it has been determined that an IC card is thus inserted (S8: YES), then furthermore in a step S9 the points and the score which have been acquired during this typing game, which are stored in the RAM 54, are both written by the card reader-writer 65 into the IC tag which is mounted on the IC card. It should be understood that the data which are written here may be referred to by the data contents display procedure of the step S3.

On the other hand, if it has been decided that an IC card is not inserted (S8: NO), then this procedure terminates.

Next, the song selection processing program of the step S5 which is performed by this typing game apparatus 1 will be explained with reference to FIG. 12. FIG. 12 is a flow chart showing the song selection processing program of the typing game apparatus according to this embodiment.

In the song selection procedure, first, in a step S11, the names of the songs and the artist names (in this embodiment, for a maximum of eight songs) related to the music data which are stored are both acquired from the music data storage region 56 of the HDD 55.

And, based on the names of the songs and names of the artists which were acquired in the above step S11, the song selection screen 15 (refer to FIG. 2) is displayed on the first liquid crystal display 3 (in a step S12). On this song selection screen 15, the names of the songs which have been acquired are displayed as a list in the playable song display sections 16, and furthermore the name of the song which is currently being selected by the song selection cursor 17 and the name of its artist are displayed in the selected song name display section 18 and in the selected artist name display section 19, respectively.

Next, in a step S13, a determination is made as to whether or not a cursor key 114 is pressed down. Here, it is determined whether or not a cursor key 114 is pressed down, based on the actuation signal which is transmitted from the keyboard 6, and if it has been determined that a cursor key 114 is pressed down (S13: YES), then, based on the cursor key 114 which has been actuated (i.e. on which of the up, down, left, and right keys has been pressed down) the song selection cursor 17 which is displayed on the first liquid crystal display 3 is shifted in the direction in which a cursor key 114 has been pressed down (in a step S14).

Moreover, in a step S15, the displays of the selected song name display section 18 and of the selected artist name display section 19 are respectively changed to the song name and the artist name which correspond to the song which is newly selected by the song selection cursor 17 which has been shifted in the above step S14. Thereafter, the flow of control returns to the determination procedure of the step S13.

On the other hand, if has been determined that no cursor key 114 is being pressed down (S13: NO), then in a next step S16 it is determined whether or not the enter key 112 has been pressed down. And, if it is determined that the enter key 112 has been pressed down (S16: YES), then the song at which the song selection cursor 17 is currently positioned is set as the song for which this typing game is to be performed (in a step S17), and the typing game which will be described hereinafter is started. On the other hand, if it is determined that the enter key 112 is not being pressed down (S16: NO), then the flow of control returns again to the determination procedure of the step S13.

Next, the typing game execution processing program of the above step S6 which is performed by this typing game apparatus 1 will be explained with reference to FIG. 13. FIG. 13 is a flow chart showing the typing game execution processing program performed by the typing game apparatus according to this embodiment.

In this typing game execution procedure, first, in a step S21, the CPU 51 reads out the music data which corresponds to the song which was selected by the song selection procedure of the above step S5 from among the music data stored in the respective storage regions (refer to FIG. 10) of the music data storage region 56 of the HDD. And, in particular, the lyrics data stored in the lyrics data storage region 56D is temporarily stored in the RAM 54, divided up into single phrases.

Next, in a step S22, the main game screen 21 (refer to FIG. 3B and FIG. 4B) is displayed on the first liquid crystal display 3. At this time, the independent image region 101 is provided at the upper central portion of this main game screen 21 on the first liquid crystal display 3. It should be understood that, at this time point, character strings are not displayed in the lyrics display section 23 on the main game screen 21, and also the displays of the score and the points in the acquired score display section 27 are both “0”. Moreover, at this time point, no image 20 of any PV is displayed in the independent image region 101.

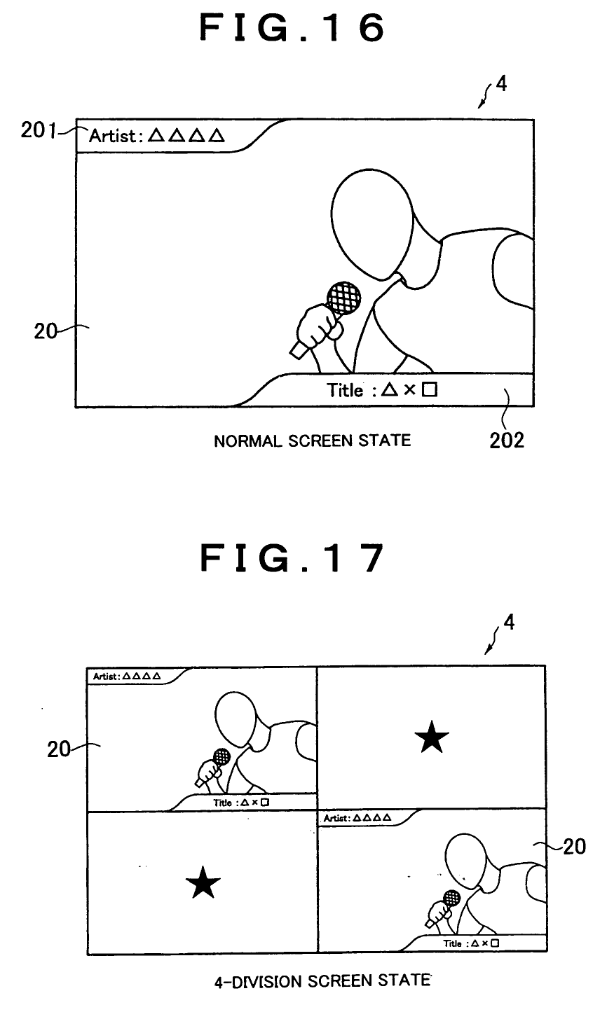

Next, in a step S23, based on the image data which is stored in the image data storage region 59, displays of an image 20 of a PV related to the song which has been selected are started at the same timing in the independent image region 101 of the main game screen 21 on the first liquid crystal display 3, and on the second liquid crystal display 4 (refer to FIG. 3A and FIG. 4A). At this time, as will be described hereinafter, on the second liquid crystal display 4, as for example shown in FIG. 16, the image 20 of the PV is displayed on the entire screen of the second liquid crystal display 4. Furthermore, via the speakers 8, output is performed both of the accompanying music, based on the musical accompaniment data which is stored in the musical accompaniment data storage region 56B, and of voice, based on the voice data which is stored in the voice data storage region 56C. By doing this, the song is performed, and moreover the image 20 of the PV is reproduced along therewith.

Next, in a step S24, the lyrics of one phrase of the lyrics data which is stored in the RAM 54 are acquired, and the corresponding character strings are displayed in the lyrics display section 23 of the main game screen 21, in accordance with the tempo of the musical accompaniment of the song. By doing this, a display of the main game screen 21 is performed on the first liquid crystal display 3, in parallel with the musical accompaniment of the song and with the display of the PV image 20 on the second liquid crystal display 4 (refer to FIG. 3B and FIG. 4B).

Thereafter, based on the one phrase of lyrics data which have been acquired, the number of characters (n) in this single phrase is calculated (in a step S25), and 0 is written into a variable (m) stored in the RAM 54 (in a step S26). Here, this variable (m) is a variable which is used in the input determination of characters corresponding to the characters which make up the single phrase, and it is incremented by 1 each time the input determination for one character is completed (in a step S33). Accordingly, in the input determination procedures which are repeatedly performed in the following steps S27 through S34, when m=t (where 0=t=n−1), input determination comes to be performed for the character which is positioned in the (t+1)-th position from the head of the single phrase.

And, in a step S27, based on the operation signal from the keyboard 6, a determination is made as to whether or not a key input has been performed with a character input key 111. If it has been determined that a key input has been performed (S27: YES), then a correctness determination procedure for the key which has been input is performed (in a step S28), based on the type of the key which has been pressed down and on the determination standard data which is stored in the determination standard data storage region 56E. In concrete terms, if that key which corresponds to the Alphabet letter displayed in the lyrics display section 23 (refer to FIG. 3B and FIG. 4B) of the main game screen 21 has been pressed down, then it is recognized as having been correctly typed. And, if it has been determined that any key other than this corresponding key has been pressed down, then 1 is added to the error number. After this, the flow of control proceeds to a step S31.

On the other hand, if it has been determined (S27: NO) that no key input has taken place, then, based on information from the timer 58, a determination is made (in a step S29) as to whether a predetermined time period has elapsed (which, when the character at the head of the single phrase is to be input, measures from after the character string which corresponds to the single phrase on the main game screen 21 has been displayed (in the step S24), and which, when some other character is to be input, measures from after the calculation procedure for the score has been performed (in a step S32)). And if it is determined that the predetermined time period has not elapsed (S29: NO), then the flow of control returns to the determination procedure of the step 27.

On the other hand, if it has been determined that the predetermined time period has elapsed (S29: YES), then it is taken that key input has not been performed by the player, and 1 is added (in a step S30) to the error number of the current game which is stored in the RAM 54.

Next, in a step S31, the key illumination procedure for the full color LEDs 155 which are provided in the interiors of the keys of the keyboard 6 is performed. In concrete terms, with the typing game apparatus 1 according to this embodiment, if key input has been performed (S27: YES), and if moreover a determination has been made that this key has been correctly typed, then the character input key 111 which has been pressed down is illuminated in blue color. Furthermore if, while key input has been performed (S27: YES), a determination has however been made that this key has been mistakenly typed, then the character input key 111 which has been pressed down is illuminated in red color, while the correct key which should have been pressed down is illuminated in green color.

Furthermore, if no key input has taken place (S27: NO), then the correct key which should have been pressed down is illuminated in green color.

Moreover, in a step S32, a procedure for calculating the score is performed, based on the correctness determination procedure of the step S28 described above.

In this score calculation procedure, the score of the player for the current game which is stored in the RAM 54 is added to if, in the determination by the above correctness determination procedure, it has been determined that the typing was correct, and furthermore, if it has been determined that the corresponding character was typed (struck) at the same timing as that of the voice of the song which is being performed, then the score is further added to.

Thereafter, in a step S33, the variable (m) which is stored in the RAM 54 is read out, +1 is added thereto, and it is again stored. Next, in a step S34, a determination is made as to whether or not the value of the variable (m) has arrived at the value n−1; in other words, it is determined whether or not the character input determinations for the characters which make up the single phrase have all been completed.

And, if it has been determined that the value of the variable (m) has not arrived at n−1 (S34: NO), then the flow of control returns back to the step S27, and the input determination is performed for the character which is positioned next in order among the characters which make up the single phrase.

On the other hand, if it has been determined that the value of the variable (m) has arrived at n−1 (S34: YES), then, since the input of the characters in the single phrase has been completed, the point addition procedure is performed in a step S35. In this point addition procedure, 1 is added to the points, if it has been determined that the input has been completed for all of the (n) characters which make up the single phrase without making any typing errors (including the determination of a typing error due to lapse of the predetermined time period (S30)).

Furthermore, in a step S36, a determination is made as to whether or not the input determination has been completed for all of the phrases of the stage corresponding to whichever is the current verse, among the plurality of verses which make up the song (normally one song consists of verses 1 to 3). And, if it has been determined (S36: NO) that input determination has not been completed for all of the phrases for one stage, then the flow of control returns to the step S24, then the lyrics of the next phrase are acquired from the RAM 54, and the corresponding character strings are displayed in the lyrics display section 23 of the main game screen 21.

On the other hand, if it has been determined (S36: YES) that the input determination has been completed for all of the phrases for this current stage, then a determination is made (in a step S37) as to whether or not the input determination has been completed for the phrases of all the stages (i.e. for the entire song).

And, if it has been determined that all of the stages have been completed (S37: YES), then, irrespective of the points currently possessed by the player, this typing game execution procedure is completed, and the flow of control shifts to the game result display procedure of the step S7. On the other hand, if it has been determined that all of the stages have not yet been completed (S37: NO), then a determination is made (in a step S38) as to whether or not the number of typing errors by the player up till the present, which has been added up in the above described steps S28 and S30, is less than a predetermined number. With the typing game apparatus 1 according to this embodiment, the game is made up from a plurality of stages which correspond to the number of verses in the song which is being reproduced, and, at the time point that one stage has been completed, the condition in order to go on to perform the stage related to the next verse is that the number of typing errors from when playing started is less than a predetermined number (for example, that the number of typing errors is less than 20 when going on to perform the second verse after having played the portion corresponding to the first verse, and that it is less than 35 when going on to perform the third verse after having played the portion corresponding to the second verse).

And, if it has been determined that the number of typing errors by the player up till the present, which has been added up in the above described steps S28 and S30, is less than the predetermined number (S38: YES), then the flow of control returns to the step S24, and the lyrics which correspond to the first phrase of the next verse of the song are acquired from the RAM 54, and the corresponding character strings are displayed on the main game screen 21 in the lyrics display section 23. And the input determination procedure is performed in the same manner. On the other hand, if it has been determined that the number of typing errors by the player up till the present is greater than or equal to the predetermined number (S38: NO), then this typing game execution procedure terminates, and the flow of control shifts to the game result display procedure of the step S7.

Furthermore, with the typing game apparatus 1 according to this embodiment, as described above, although the song of the vocalist is reproduced as the song, and the game progresses by the player inputting the lyrics of the song via the keyboard 6, at this time, an image 20 of the PV related to this song is displayed on the second liquid crystal display 4 (refer to FIG. 3A and FIG. 4A). And, here, there are six possible modes for the display state of this image 20 of the PV which is displayed on the second liquid crystal display 4: a normal screen state, a 4-division screen state, a first 16-division screen state, a second 16-division screen state, a third 16-division screen state, and a fourth 16-division screen state.

Moreover, by the normal screen state is meant a state in which the image 20 of the PV is displayed full screen on the second liquid crystal display 4, like for example the state shown in FIG. 16.

Furthermore, by the 4-division screen state is meant a state in which the screen of the second liquid crystal display 4 has been divided into two equal portions both horizontally and vertically, and the image 20 of a PV is displayed in each of two of the resulting total of four separated sections, like for example the state shown in FIG. 17. Moreover, the positions of the two 4-division screens on which the image 20 of the PV is displayed are not necessarily limited to being the positions shown in FIG. 17; and furthermore, they may not be fixed, but may shift around. Yet further, here, a state would also be acceptable in which the image 20 of the PV is displayed in all of the four 4-division screens.

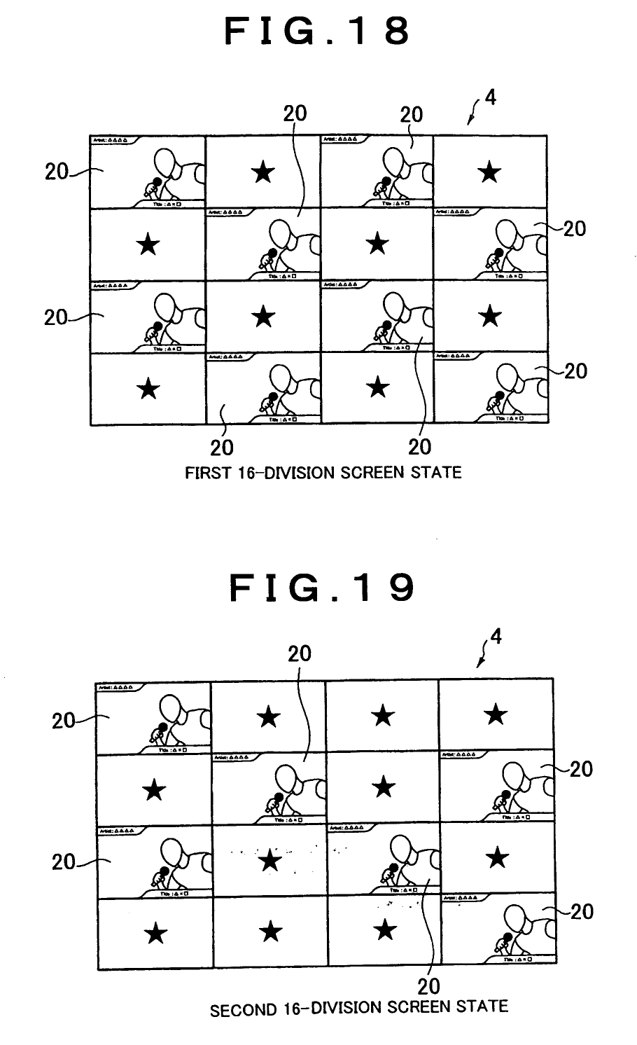

Furthermore, by the first 16-division screen state is meant a state in which the screen of the second liquid crystal display 4 has been divided into four equal portions both horizontally and vertically, and the image 20 of a PV is displayed in each of eight of the resulting total of sixteen separated sections, like for example the state shown in FIG. 18. Moreover, the positions of the eight 16-division screens on which the image 20 of the PV is displayed are not necessarily limited to being the positions shown in FIG. 18; and furthermore they may not be fixed, but may shift around.

Furthermore, by the second 16-division screen state is meant a state in which the screen of the second liquid crystal display 4 has been divided into four equal portions both horizontally and vertically, and the image 20 of a PV is displayed in each of six of the resulting total of sixteen separated sections, like for example the state shown in FIG. 19. Moreover, the positions of the six 16-division screens on which the image 20 of the PV is displayed are not necessarily limited to being the positions shown in FIG. 19; and furthermore they may not be fixed, but may shift around.

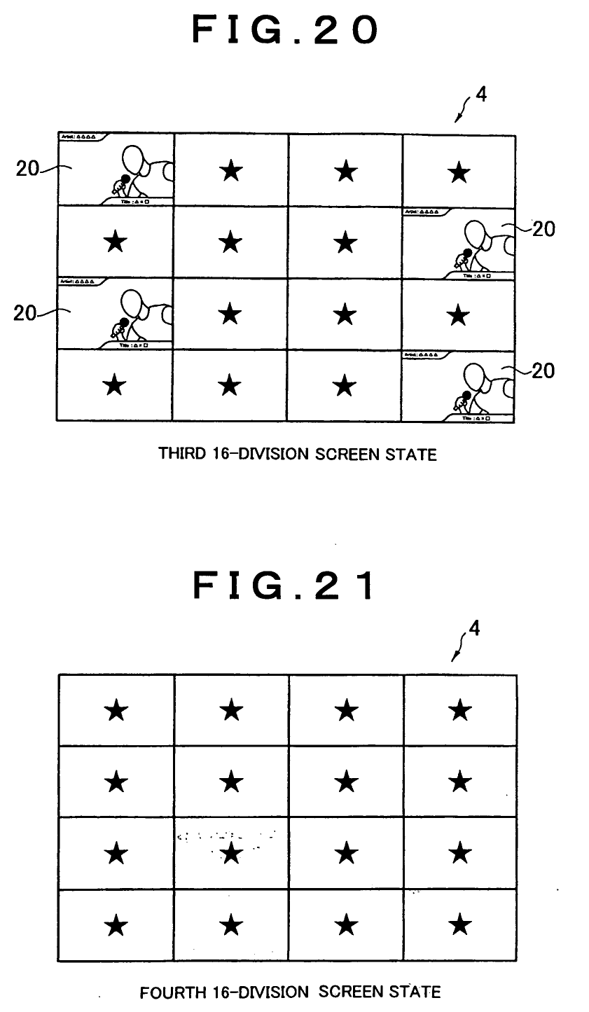

Furthermore, by the third 16-division screen state is meant a state in which the screen of the second liquid crystal display 4 has been divided into four equal portions both horizontally and vertically, and the image 20 of a PV is displayed in each of four of the resulting total of sixteen separated sections, like for example the state shown in FIG. 20. Moreover, the positions of the four 16-division screens on which the image 20 of the PV is displayed are not necessarily limited to being the positions shown in FIG. 20; and furthermore they may not be fixed, but may shift around.

Furthermore, by the fourth 16-division screen state is meant a state in which the screen of the second liquid crystal display 4 has been divided into four equal portions both horizontally and vertically, but the image 20 of a PV is not displayed in any of the resulting total of sixteen separated sections, like for example the state shown in FIG. 21.

It should be understood that, as shown in FIG. 17 through FIG. 21, here, a star is displayed on the divided portions of the screen in which the image 20 of the PV is not being displayed. Furthermore although, in FIG. 16 through FIG. 20, the image 20 of a PV of a male artist who is singing is displayed as shown in FIG. 3A, in the same manner, the image 20 of a PV of a female artist who is singing may be displayed, as shown in FIG. 4A.

And, with the typing game apparatus 1 according to this embodiment, while the first verse of the song is being reproduced, always, the display state of the image 20 of the PV which is being displayed on the second liquid crystal display 4 is made to be the normal screen state, as for example shown in FIG. 16. However if, after the first verse of the song has been reproduced, the input of the (n) characters which make up a single phrase has not been continuously performed to the end without making any typing errors (including the determination (in the above described step S30) of a typing error due to the predetermined time period elapsing), or, in other words, if one point at a time has not been continued to be acquired, then it is not possible for the player to keep the display state of the image 20 of the PV which is being displayed on the second liquid crystal display 4 in the normal screen state.

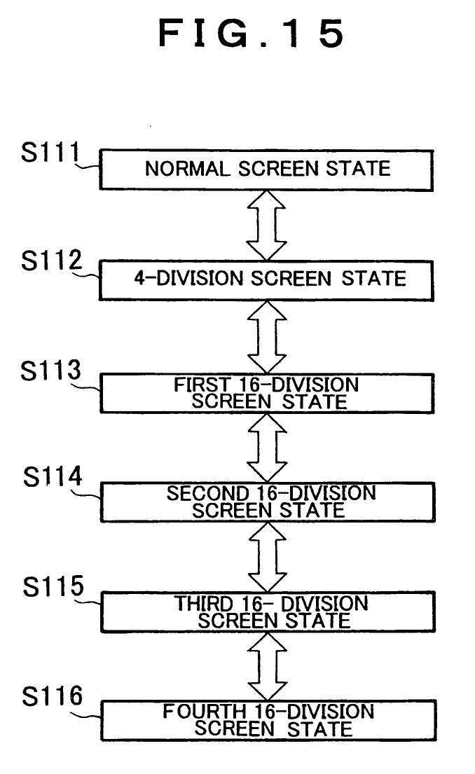

In other words, after the first verse of the song has been reproduced, the display state of the image 20 of the PV which is being displayed on the second liquid crystal display 4 shifts as shown in FIG. 15.

First, when the display state of the image 20 of the PV which is being displayed on the second liquid crystal display 4 is the normal screen state (the step S111), when the player has not been able to complete inputting the (n) characters which make up the single phrase without making a typing error (including the determination (in the above described step S30) of a typing error due to the predetermined time period elapsing), in other words if he has not been able to acquire even a single point, then the display state of the image 20 of the PV which is being displayed on the second liquid crystal display 4 shifts (in the step S112), for example, from this normal screen state of FIG. 16 to the 4-division screen state of FIG. 17 (the step S112).

Furthermore, when the display state of the image 20 of the PV which is displayed on the second liquid crystal display 4 is the 4-division screen state (S112), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this 4-division screen state of FIG. 17 to the first 16-division screen state of FIG. 18 (the step S113).

Moreover, when the display state of the image 20 of the PV which is displayed on the second liquid crystal display 4 is the first 16-division screen state (the step S113), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this first 16-division screen state of FIG. 18 to the second 16-division screen state of FIG. 19 (the step S114).

Yet further, when the display state of the image 20 of the PV which is displayed on the second liquid crystal display 4 is the second 16-division screen state (the step S114), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this second 16-division screen state of FIG. 19 to the third 16-division screen state of FIG. 20 (the step S115).

Yet further, if the display state of the image 20 of the PV which is displayed on the second liquid crystal display 4 is the third 16-division screen state (the step S115), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this third 16-division screen state of FIG. 20 to the fourth 16-division screen state of FIG. 21 (the step S116).

It should be understood that, if the display state of the image 20 of the PV which is displayed on the second liquid crystal display 4 is the fourth 16-division screen state (the step S116), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 is, for example, maintained at the fourth 16-division screen state of FIG. 21 (the step S116).

On the other hand, if the display state of the image 20 of the PV which is displayed on the second liquid crystal display 4 is the fourth 16-division screen state (the step S116), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this fourth 16-division screen state of FIG. 21 to the third 16-division screen state of FIG. 20 (the step S115).

Moreover, if the display state of the image 20 of the PV which is displayed on the second liquid crystal display 4 is the third 16-division screen state (the step S115), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this third 16-division screen state of FIG. 20 to the second 16-division screen state of FIG. 19 (the step S114).

Still further, if the display state of the image 20 of the PV which is displayed on the second liquid crystal display 4 is the second 16-division screen state (the step S114), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this second 16-division screen state of FIG. 19 to the first 16-division screen state of FIG. 18 (the step S113).

Even further, if the display state of the image 20 of the PV which is displayed on the second liquid crystal display 4 is the first 16-division screen state (the step S113), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this first 16-division screen state of FIG. 18 to the 4-division screen state of FIG. 17 (the step S112).

Yet further, if the display state of the image 20 of the PV which is displayed on the second liquid crystal display 4 is the 4-division screen state (the step S112), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this 4-division screen state of FIG. 17 to the normal screen state of FIG. 16 (the step S111).

Finally, if the display state of the image 20 of the PV which is displayed on the second liquid crystal display 4 is the normal screen state (the step S111), when the player has been able to complete inputting the (n) characters which make up the single phrase without making a typing error (including the determination (in the above described step S30) of a typing error due to the predetermined time period elapsing), in other words when he has been able to acquire at least one single point, then, for example, the display state of the image 20 of the PV which is being displayed on the second liquid crystal display 4 is maintained at the normal screen state of FIG. 16 (in the step S111).

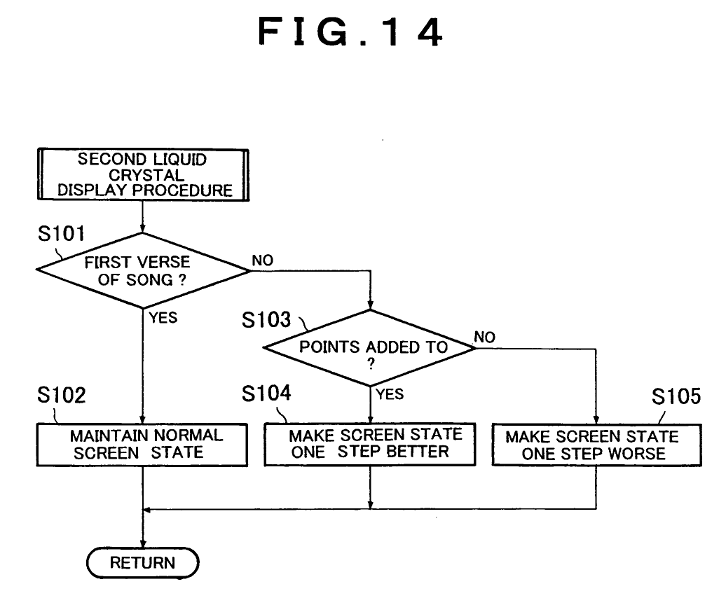

And, with the typing game apparatus 1 of this embodiment, as described above, in order to control the display state of the image 20 of the PV which is displayed on the second liquid crystal display 4, at the time point W1 at which the flow of control returns from the step S36 or the step S38 of the typing game execution procedure shown in FIG. 13 to the step S24, a second liquid crystal display procedure is executed. Here, this second liquid crystal display procedure will be explained with reference to FIG. 14. FIG. 14 is a flow chart showing the second liquid crystal display processing program of the typing game apparatus according to this embodiment.

As shown in FIG. 14, in this second liquid crystal display procedure, first, in a step S101, a decision is made as to whether or not the first verse of the song is being reproduced. If it is determined that, at this time, the first verse of the song is being reproduced, (S101: YES), then the flow of control proceeds to a step S102, and the display state for the image 20 of the PV which is being displayed on the second liquid crystal display 4 is maintained in the present state; in other words, for example, the normal screen state as shown in FIG. 16 is maintained, and thereafter the flow of control goes back to the typing game execution procedure shown in FIG. 13, and returns to the step S24.

On the other hand, if it has been determined that it is not the first verse of the song which is being reproduced (S101: NO), then the flow of control proceeds to a step S103, in which it is determined whether or not point addition has been performed. Here by point addition is meant, that addition of a point has been made in the step S35 of the typing game execution procedure shown in FIG. 13 which was performed directly before this procedure.

If, at this time, it has been determined that point addition has been performed (S103: YES), then the flow of control proceeds to the step S104, and the display state of the image 20 of the PV which is being displayed on the second liquid crystal display 4 is made one step better. Thereafter, the flow of control goes back to the typing game execution procedure shown in FIG. 13, and returns to the step S24.

Here, to make the display state of the image 20 of the PV which is being displayed on the second liquid crystal display 4 one step better, means any of: to maintain the normal screen state (i.e. to maintain the step S111 of FIG. 15), or to shift from the 4-division screen state to the normal screen state (i.e. to shift from the step S112 of FIG. 15 to the step S111), or to shift from the first 16-division screen state to the 4-division screen state (i.e. to shift from the step S113 of FIG. 15 to the step S112), or to shift from the second 16-division screen state to the first 16-division screen state (i.e. to shift from the step S114 of FIG. 15 to the step S113), or to shift from the third 16-division screen state to the second 16-division screen state (i.e. to shift from the step S115 of FIG. 15 to the step S114), or to shift from the fourth 16-division screen state to the third 16-division screen state (i.e. to shift from the step S116 of FIG. 15 to the step S115).

On the other hand, if it has been determined that point addition has not been performed (S103: NO), then the flow of control proceeds to the step S105, and the display state of the image 20 of the PV which is being displayed on the second liquid crystal display 4 is made one step worse, and thereafter the flow of control goes back to the typing game execution procedure shown in FIG. 13, and returns to the step S24.

Here, to make the display state of the image 20 of the PV which is being displayed on the second liquid crystal display 4 one step worse, means any of: to shift from the normal screen state to the 4-division screen state (i.e. to shift from the step S111 of FIG. 15 to the step S112), or to shift from the 4-division screen state to the first 16-division screen state (i.e. to shift from the step S112 of FIG. 15 to the step S113), or to shift from the first 16-division screen state to the second 16-division screen state (i.e. to shift from the step S113 of FIG. 15 to the step S114), or to shift from the second 16-division screen state to the third 16-division screen state (i.e. to shift from the step S114 of FIG. 15 to the step S115), or to shift from the third 16-division screen state to the fourth 16-division screen state (i.e. to shift from the step S115 of FIG. 15 to the step S116), or to maintain the fourth 16-division screen state (i.e. to maintain the step S116 of FIG. 15).

Accordingly, when executing the step S28, the CPU 51 functions as a “correctness determination means”.

Moreover, when executing the step S101, the CPU 51 functions as a “first condition determination means”.

And, when executing the step S103, the CPU 51 functions as a “second condition determination means”.

Yet further, when executing the step S23 and the step S102, the CPU 51 and the display control circuit 60 function as a “full screen display control means”.

Even further, when executing the step S105, the CPU 51 and the display control circuit 60 function as a “screen division display control means”.

Still further, when executing the step S104, the CPU 51 and the display control circuit 60 function as a “division elimination display control means”.

As explained above, with the typing game apparatus 1 according to this embodiment, on the one hand, since, when the song which is being performed is not in a predetermined state, the screen on which the image data are being displayed is divided into a plurality of sections when the evaluation related to typing is unfavorable, due to it having been determined that the result of determination is not above the predetermined standard, so that it is possible for the skill related to typing to appeal to an onlooker via the display state of the image data which is attractive and entices the public, on the other hand, since the image data is always displayed clearly in a full screen manner when the song which is being performed is in the predetermined state, accordingly it is also possible sufficiently to manifest a beneficial effect for publicity directed towards the promotion of the sales of a CD or a DVD or the like which contains image data.

In other words, on the one hand, since, with the typing game apparatus 1 according to this embodiment, when the section of the song which is being reproduced is not its first verse (S101: NO), when the player has not been able to complete inputting the (n) characters which make up a single phrase without making a typing error (including the determination (in the above described step S30) of a typing error due to the predetermined time period elapsing), in other words when it is determined (S103: NO) that he has not been able to acquire even a single point, so that the evaluation related to typing is in an unfavorable state, then the display state of the image 20 of the PV which is being displayed on the second liquid crystal display 4 is made one step worse (in the step S105), i.e., as shown by the order of FIG. 16 to FIG. 18, the screen of the second liquid crystal display 4 on which the image 20 of the PV of this song is being displayed is divided into a plurality of sub-screens, or, as shown by the order of FIG. 18 to FIG. 21, the number of 16-division screens of the second liquid crystal display 4 on which the image 20 of the PV of this song is being displayed is reduced, accordingly it is possible for the skill related to typing to appeal to the onlookers via the state of the display of the image 20 of the PV, which possesses an attractiveness which entices the public; and, on the other hand, since only when the section of the song which is being reproduced is its first verse (S101: YES), then, as shown in FIG. 16, the image 20 of the PV of this song is always displayed clearly in a full screen manner on the second liquid crystal display 4 (in the step S102), accordingly it is possible sufficiently to manifest a beneficial effect for publicity directed towards the promotion of the sales of a CD or a DVD or the like which contains image data.

Furthermore since, when the section of the song which is being reproduced is not its first verse (S101: NO), and when the player has been able to complete inputting the (n) characters which make up a single phrase without making a typing error (including the determination (in the above described step S30) of a typing error due to the predetermined time period elapsing), in other words when it is determined (S103: YES) that he has been able to acquire a single point, so that the evaluation related to typing is in a favorable state, then the display state of the image 20 of the PV which is being displayed on the second liquid crystal display 4 is made one step better (in the step S104), i.e., as shown by the order of FIG. 21 to FIG. 18, the number of 16-division screens of the second liquid crystal display 4 on which the image 20 of the PV of this song is being displayed is increased, or, as shown by the order of FIG. 18 to FIG. 16, the divided screens of the second liquid crystal display 4 on which the image 20 of the PV of this song is being displayed are combined together, accordingly it is possible for the skill related to typing to appeal to the onlookers via the state of the display of the image 20 of the PV, which possesses an attractiveness which entices the public

It should be understood that the present invention is not limited to the embodiment described above; various changes to any embodiment are acceptable, provided that the gist of the present invention is not departed from. For example while, in the above described embodiment, when the section of the song which is being reproduced is not its first verse (S101: NO), whether to make the display state of the image 20 of the PV which is being displayed on the second liquid crystal display 4 one step better (in the step S104) or to make it one step worse (in the step S105), is made to depend (in the step S103) on whether or not the player has been able to complete inputting the (n) characters which make up a single phrase without making a typing error (including the determination (in the above described step S30) of a typing error due to the predetermined time period elapsing), in other words on whether or not (in the step S103) he has been able to acquire a single point, it would also be acceptable to make it depend on whether or not any key other than a key which corresponds to the Alphabet letters which are displayed on the lyrics display section 23 (refer to FIG. 3B and FIG. 4B) of the main game screen 21 has been pressed down, or on whether or not the player has not performed any key input even though the predetermined time period has elapsed, in other words on whether or not 1 has been added to the error number.

### The Second Embodiment

In the following, a typing game apparatus according to the second embodiment of the present invention will be explained. However, since many portions thereof have the same structure as the typing game apparatus according to the first embodiment of the present invention described above (FIGS. 1 through 14 and the explanation relating thereto), the explanation of these overlapping portions will be severely curtailed. In other words, since the typing game apparatus according to the second embodiment and the typing game apparatus according to the first embodiment principally mutually differ, when the evaluation related to typing is in unfavorable state, in relation to the features of the display condition of an abnormal screen state which is different from the normal screen state, accordingly, in the following, the explanation will mainly focus on these points of difference.

Further while, with this typing game apparatus 1 according to the second embodiment, a song by a vocalist is reproduced as the song, and the player progresses through the game by performing input of the lyrics of the song with a keyboard 6, as described above, at this time an image 20 of a PV related to this song is displayed on the second liquid crystal display 4 (refer to FIG. 3A and FIG. 4A). And, here, there are six possibilities for the display state of the image 20 of the PV which is displayed on the second liquid crystal display 4: a normal screen state, a first noisy screen state, a second noisy screen state, a third noisy screen state, a fourth noisy screen state, and a fifth noisy screen state.

Moreover, by the normal screen state, is meant the state in which the image 20 of the PV is displayed on the entire screen of the second liquid crystal display 4, as for example, shown in FIG. 16.

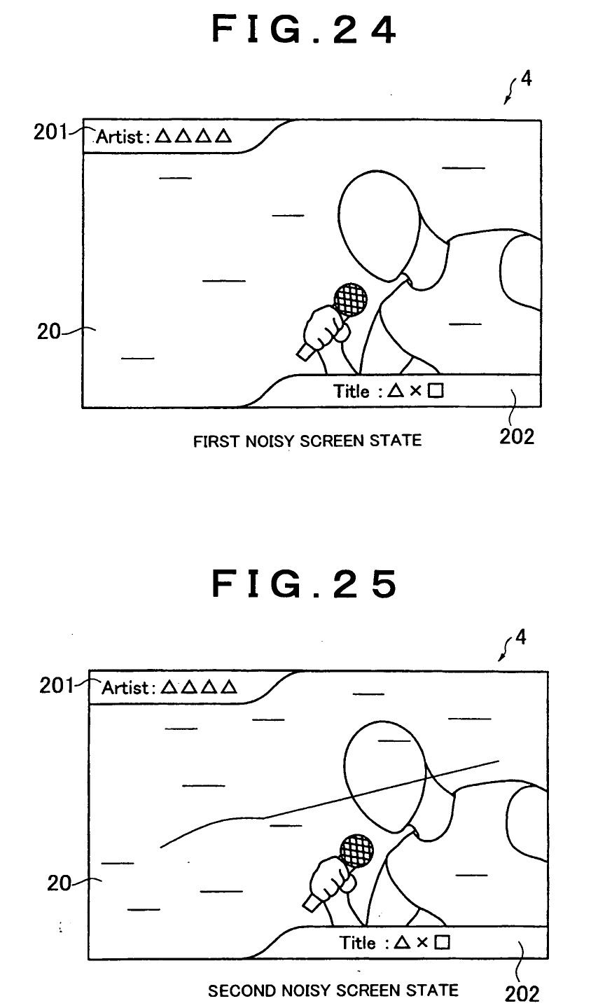

Furthermore, by the first noisy screen state, is meant a state in which a little noise is present in the full screen display of the image 20 of the PV on the second liquid crystal display 4, so that it is somewhat harder to see as compared to the normal screen state, as for example, shown in FIG. 24.

Furthermore, by the second noisy screen state, is meant a state in which more noise than in the case of the above described first noisy screen state is present in the full screen display of the image 20 of the PV on the second liquid crystal display 4, so that it is somewhat harder to see as compared with the above described first noisy screen state, as for example, shown in FIG. 25.

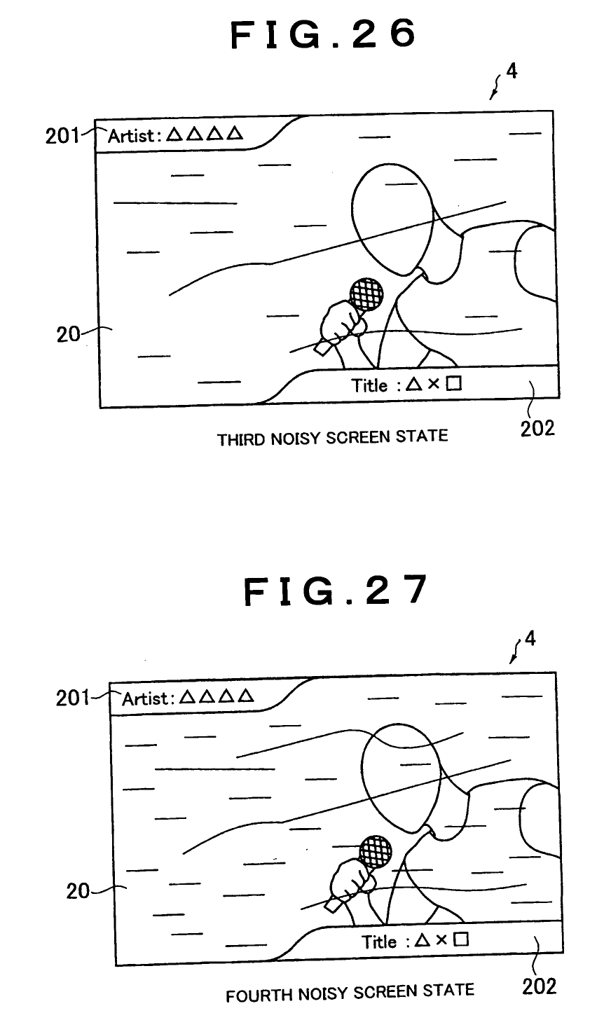

Furthermore, by the third noisy screen state, is meant a state in which more noise than in the case of the above described second noisy screen state is present in the full screen display of the image 20 of the PV on the second liquid crystal display 4, so that it is somewhat harder to see as compared with the above described second noisy screen state, as for example, shown in FIG. 26.

Furthermore, by the fourth noisy screen state, is meant a state in which more noise than in the case of the above described third noisy screen state is present in the full screen display of the image 20 of the PV on the second liquid crystal display 4, so that it is somewhat harder to see as compared with the above described third noisy screen state, as for example, shown in FIG. 27.

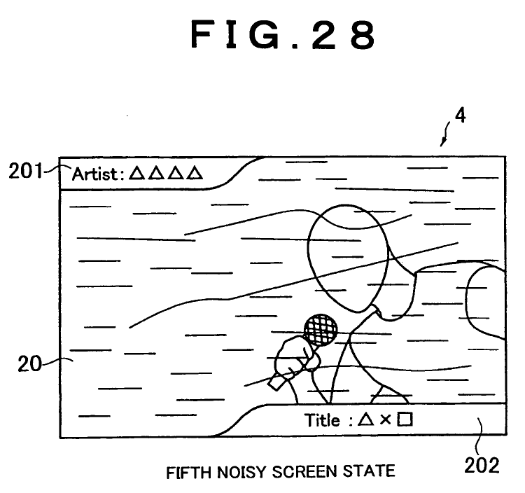

Furthermore, by the fifth noisy screen state, is meant a state in which more noise than in the case of the above described fourth noisy screen state is present in the full screen display of the image 20 of the PV on the second liquid crystal display 4, so that it is somewhat harder to see as compared with the above described fourth noisy screen state, as for example, shown in FIG. 28.

It should be understood that although, in FIG. 16 and FIGS. 24 through 28, the image 20 shown in FIG. 3A of a PV of a male artist who is singing is displayed, it would also be possible to display the image 20 shown in FIG. 4A of a PV of a female artist who is singing, in the same manner.

And, with the typing game apparatus 1 according to this second preferred embodiment, when the first verse of the song is being reproduced, always, the display state of the image 20 of the PV which is being displayed on the second liquid crystal display 4 is made to be the normal screen state, as for example shown in FIG. 16. However if, after the first verse of the song has been reproduced, the input of the (n) characters which make up a single phrase has not been continuously performed to the end without making any typing errors (including the determination (in the above described step S30) of a typing error due to the predetermined time period elapsing), or, to express it in another manner, if one point at a time has not been continued to be acquired, then it is not possible for the player to keep the display state of the image 20 of the PV which is being displayed on the second liquid crystal display 4 in the normal screen state.

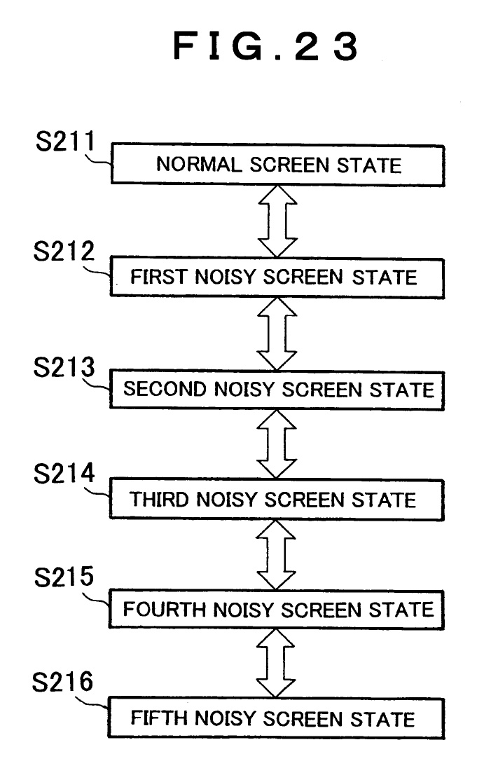

In other words, after the first verse of the song has been reproduced, the display state of the image 20 of the PV which is being displayed on the second liquid crystal display 4 shifts as shown in FIG. 23.

First, when the display state of the image 20 of the PV which is being displayed on the second liquid crystal display 4 is the normal screen state (the step S211), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this normal screen state of FIG. 16 to the first noisy screen state of FIG. 24 (the step S212).

Furthermore, when the display state of the image 20 of the PV which is displayed on the second liquid crystal display 4 is the first noisy screen state (the step S212), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this first noisy screen state of FIG. 24 to the second noisy screen state of FIG. 25 (the step S213).

Moreover, when the display state of the image 20 of the PV which is displayed on the second liquid crystal display 4 is the second noisy screen state (the step S213), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this second noisy screen state of FIG. 25 to the third noisy screen state of FIG. 26 (the step S214).

Yet further, when the display state of the image 20 of the PV which is displayed on the second liquid crystal display 4 is the third noisy screen state (the step S214), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this third noisy screen state of FIG. 26 to the fourth noisy screen state of FIG. 27 (the step S215).

Even further, when the display state of the image 20 of the PV which is displayed on the second liquid crystal display 4 is the fourth noisy screen state (the step S215), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 shifts, for example, from this fourth noisy screen state of FIG. 27 to the fifth noisy screen state of FIG. 28 (the step S216).

It should be understood that, if the display state of the image 20 of the PV which is displayed on the second liquid crystal display 4 is the fifth noisy screen state (the step S216), when the player has not been able to complete inputting the (n) characters which make up the single phrase without making a typing error (including the determination (in the above described step S30) of a typing error due to the predetermined time period elapsing), in other words when he has not been able to acquire even a single point, then the display state of the image 20 of the PV which is being displayed on the second liquid crystal display 4 is, for example, maintained at the fifth noisy screen state of FIG. 28 (the step S216).

On the other hand, if the display state of the image 20 of the PV which is displayed on the second liquid crystal display 4 is the fifth noisy screen state (the step S216), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this fifth noisy screen state of FIG. 28 to the fourth noisy screen state of FIG. 27 (the step S215).

Moreover, if the display state of the image 20 of the PV which is displayed on the second liquid crystal display 4 is the fourth noisy screen state (the step S215), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this fourth noisy screen state of FIG. 27 to the third noisy screen state of FIG. 26 (the step S214).

Yet further, if the display state of the image 20 of the PV which is displayed on the second liquid crystal display 4 is the third noisy screen state (the step S214), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this third noisy screen state of FIG. 26 to the second noisy screen state of FIG. 25 (the step S213).

Still further, if the display state of the image 20 of the PV which is displayed on the second liquid crystal display 4 is the second noisy screen state (the step S213), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this second noisy screen state of FIG. 25 to the first noisy screen state of FIG. 24 (the step S212).

Even further, if the display state of the image 20 of the PV which is displayed on the second liquid crystal display 4 is the first noisy screen state (the step S212), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 shifts, for example, from this first noisy screen state of FIG. 24 to the normal screen state of FIG. 16 (the step S211).

Finally, if the display state of the image 20 of the PV which is displayed on the second liquid crystal display 4 is the normal screen state (the step S211), when the player has been able to complete inputting the (n) characters which make up the single phrase without making a typing error (including the determination (in the above described step S30) of a typing error due to the predetermined time period elapsing), in other words when he has been able to acquire at least one single point, then the display state of the image 20 of the PV which is being displayed on the second liquid crystal display 4 is, for example, maintained in the normal screen state of FIG. 16 (the step S211).

And, with the typing game apparatus 1 of this second embodiment, just as with the typing game apparatus 1 of the above described first embodiment, in order to control the display state of the image 20 of the PV which is displayed on the second liquid crystal display 4, at the time point W1 at which the flow of control returns from the step S36 or the step S38 of the typing game execution procedure shown in FIG. 13 to the step S24, a second liquid crystal display procedure is executed. Here, this second liquid crystal display procedure will be explained with reference to FIG. 14. FIG. 14 is a flow chart showing the second liquid crystal display processing program of the typing game apparatus according to this second embodiment.

As shown in FIG. 14, in this second liquid crystal display procedure, first, in a step S101, a determination is made as to whether or not the first verse of the song is being reproduced. If it is determined that, at this time, the first verse of the song is being reproduced, (S101: YES), then the flow of control proceeds to a step S102, and the display state for the image 20 of the PV which is being displayed on the second liquid crystal display 4 is maintained in the present state; in other words, for example, the normal screen state as shown in FIG. 16 is maintained, and thereafter the flow of control goes back to the typing game execution procedure shown in FIG. 13, and returns to the step S24.

On the other hand, if it has been determined that it is not the first verse of the song which is being reproduced (S101: NO), then the flow of control proceeds to a step S103, in which it is determined whether or not point addition has been performed. Here by point addition is meant, that addition of a point has been made in the step S35 of the typing game execution procedure shown in FIG. 13 which was performed directly before this procedure.

If, at this time, it has been determined that point addition has been performed (S103: YES), then the flow of control proceeds to the step S104, and the display state of the image 20 of the PV which is being displayed on the second liquid crystal display 4 is made one step better. Thereafter, the flow of control goes back to the typing game execution procedure shown in FIG. 13, and returns to the step S24.

Here, to make the display state of the image 20 of the PV which is being displayed on the second liquid crystal display 4 one step better, means any of: to maintain the normal screen state (i.e. to maintain the step S211 of FIG. 23), or to shift from the first noisy screen state to the normal screen state (i.e. to shift from the step S212 of FIG. 23 to the step S211), or to shift from the second noisy screen state to the first noisy screen state (i.e. to shift from the step S213 of FIG. 23 to the step S212), or to shift from the third noisy screen state to the second noisy screen state (i.e. to shift from the step S214 of FIG. 23 to the step S213), or to shift from the fourth noisy screen state to the third noisy screen state (i.e. to shift from the step S215 of FIG. 23 to the step S214), or to shift from the fifth noisy screen state to the fourth noisy screen state (i.e. to shift from the step S216 of FIG. 23 to the step S215).

On the other hand, if it has been determined that point addition has not been performed (S103: NO), then the flow of control proceeds to the step S105, and the display state of the image 20 of the PV which is being displayed on the second liquid crystal display 4 is made one step worse, and thereafter the flow of control goes back to the typing game execution procedure shown in FIG. 13, and returns to the step S24.

Here, to make the display state of the image 20 of the PV which is being displayed on the second liquid crystal display 4 one step worse, means any of: to shift from the normal screen state to the first noisy screen state (i.e. to shift from the step S211 of FIG. 23 to the step S212), or to shift from the first noisy screen state to the second noisy screen state (i.e. to shift from the step S212 of FIG. 23 to the step S213), or to shift from the second noisy screen state to the third noisy screen state (i.e. to shift from the step S213 of FIG. 23 to the step S214), or to shift from the third noisy screen state to the fourth noisy screen state (i.e. to shift from the step S214 of FIG. 23 to the step S215), or to shift from the fourth noisy screen state to the fifth noisy screen state (i.e. to shift from the step S215 of FIG. 23 to the step S216), or to maintain the fifth noisy screen state (i.e. to maintain the step S216 of FIG. 23).

Accordingly, when executing the step S28, the CPU 51 functions as a “correctness determination means”.

Moreover, when executing the step S101, the CPU 51 functions as a “first condition determination means”.

And, when executing the step S103, the CPU 51 functions as a “second condition determination means”.

Yet further, when executing the step S23 and the step S102, the CPU 51 and the display control circuit 60 function as a “full screen display control means”.

Even further, when executing the step S105, the CPU 51 and the display control circuit 60 function as a “screen disordering display control means”.

Still further, when executing the step S104, the CPU 51 and the display control circuit 60 function as a “disordering elimination display control means”.

As explained above, with the typing game apparatus 1 according to this second embodiment, on the one hand, since, when the song which is being performed is not in a predetermined state, the screen on which the image data are being displayed is disordered when the state of the evaluation related to typing is unfavorable, due to it having been determined that the result of determination is not above the predetermined standard, so that it is possible for the skill related to typing to appeal to an onlooker via the display state of the image data which has attractiveness for enticing the public, on the other hand, since the image data is always displayed clearly in a full screen manner when the song which is being performed is in the predetermined state, accordingly it is possible also sufficiently to manifest a beneficial effect for publicity directed towards the promotion of the sales of a CD or a DVD or the like which contains image data.

In other words, with the typing game apparatus 1 according to this second embodiment, on the one hand, since, when the section of the song which is being reproduced is not its first verse (S101: NO), when the player has not been able to complete inputting the (n) characters which make up a single phrase without making a typing error (including the determination (in the above described step S30) of a typing error due to the predetermined time period elapsing), in other words when it is determined (S103: NO) that he has not been able to acquire even a single point, so that the evaluation related to typing is in an unfavorable state, then the display state of the image 20 of the PV which is being displayed on the second liquid crystal display 4 is made one step worse (in the step S105), i.e., as shown by the order of FIG. 16 and FIG. 24 to FIG. 28, the noise on the screen of the second liquid crystal display 4 on which the image 20 of the PV of this song is being displayed is made worse, accordingly it is possible for the skill related to typing to appeal to the onlookers via the state of the display of the image 20 of the PV, which possesses an attractiveness which entices the public; and, on the other hand, since only when the section of the song which is being reproduced is its first verse (S101: YES), then, as shown in FIG. 16, the image 20 of the PV of this song is always displayed clearly in a full screen manner on the second liquid crystal display 4 without generating noise therein (in the step S102), accordingly it is possible sufficiently to manifest a beneficial effect for publicity directed towards the promotion of the sales of a CD or a DVD or the like which contains image data.

Furthermore since, when the section of the song which is being reproduced is not its first verse (S101: NO), and when the player has been able to complete inputting the (n) characters which make up a single phrase without making a typing error (including the determination (in the above described step S30) of a typing error due to the predetermined time period elapsing), in other words when it is determined (S103: YES) that he has been able to acquire a single point, so that the evaluation related to typing is in a favorable state, then the display state of the image 20 of the PV which is being displayed on the second liquid crystal display 4 is made one step better (in the step S104), i.e., as shown by the order of FIG. 28 to FIG. 24 and FIG. 16, the amount of noise which is generated in the second liquid crystal display 4 on which the image 20 of the PV of this song is being displayed is progressively reduced, accordingly it is possible for the skill related to typing to appeal to the onlookers via the state of the display of the image 20 of the PV, which possesses an attractiveness which entices the public.

It should be understood that the present invention is not limited to the embodiment described above; various changes to any embodiment are acceptable, provided that the gist of the present invention is not departed from. For example, in the above described embodiment, when the section of the song which is being reproduced is not its first verse (S101: NO), whether to make the display state of the image 20 of the PV which is being displayed on the second liquid crystal display 4 one step better (in the step S104) or to make it one step worse (in the step S105), is made to depend (in the step S103) on whether or not the player has been able to complete inputting the (n) characters which make up a single phrase without making a typing error (including the determination (in the above described step S30) of a typing error due to the predetermined time period elapsing), in other words on whether or not (in the step S103) he has been able to acquire a single point.

But it would also be acceptable to make it depend on whether or not any key other than a key which corresponds to the Alphabet letters which are displayed on the lyrics display section 23 (refer to FIG. 3B and FIG. 4B) of the main game screen 21 has been pressed down, or on whether or not the player has not performed any key input even though the predetermined time period has elapsed, in other words on whether or not 1 has been added to the error number; and furthermore, in this case, as the display state of the PV of the image 20 on the second liquid crystal display 20, it would be acceptable, for example, for the six stages to be a normal screen state, a first slipped screen state, a second slipped screen state, a third slipped screen state, a fourth slipped screen state, and a fifth slipped screen state.

Basically, such a slipped screen state means a state in which some type of displacement is present in the image on the screen; for example, as described below, it could be a state in which displacement of the screen in the vertical direction (so called V-sync synchronization slippage) is present.

### The Third Embodiment

In the following, a typing game apparatus according to a third embodiment of the present invention will be explained. However, since many portions of this typing game apparatus according to the third embodiment also have the same structure as the typing game apparatus according to the first embodiment of the present invention described above (FIGS. 1 through 14 and the explanation relating thereto), the explanation of these overlapping portions will be severely curtailed. In other words, since the typing game apparatus according to the third embodiment and the typing game apparatus according to the first embodiment mainly mutually differ, when the evaluation related to typing is in an unfavorable state, in relation to the features of the display condition of an abnormal screen state which is different from the normal screen state, accordingly, in the following, the explanation will principally focus on these points of difference.

This typing game apparatus 1 according to the third embodiment is built so that there are six possibilities for the display state of the image 4 of the PV which is displayed on the second liquid crystal display 4, for example: a normal screen state, a first slipped screen state, a second slipped screen state, a third slipped screen state, a fourth slipped screen state, and a fifth slipped screen state.

Here, by the normal screen state, is meant the state in which the image 20 of the PV is displayed in full screen on the second liquid crystal display 4, as for example, shown in FIG. 16.

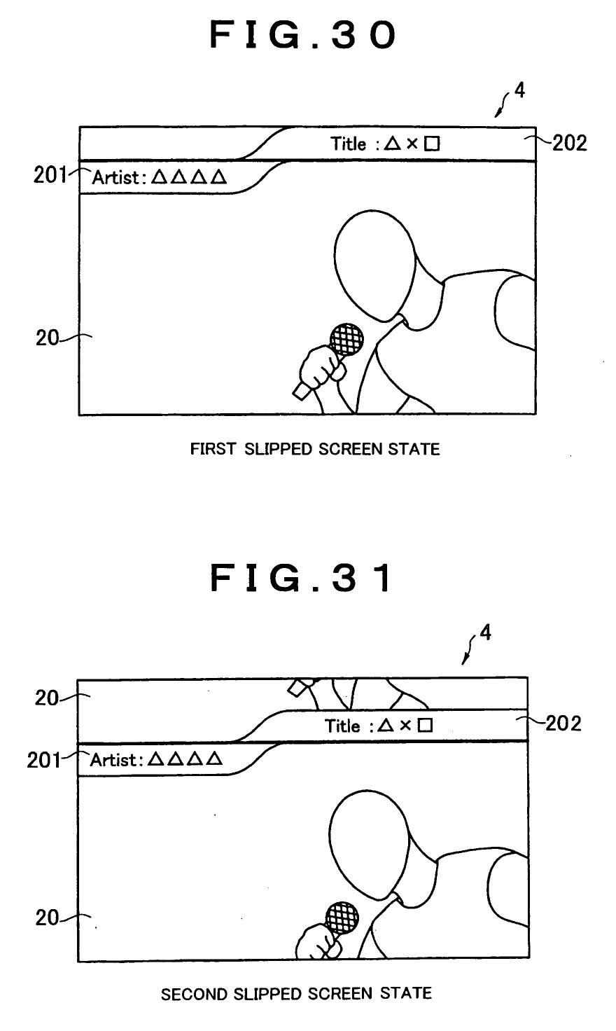

Furthermore, by the first slipped screen state, is meant a state in which a little slippage (displacement of the image in the vertical direction of the screen; and the same hereinafter) is present in the full screen display of the image 20 of the PV on the second liquid crystal display 4, so that it is somewhat harder to see as compared to the normal screen state, as for example, shown in FIG. 30.

Furthermore, by the second slipped screen state, is meant a state in which more displacement than in the case of the above described first slipped screen state is present in the full screen display of the image 20 of the PV on the second liquid crystal display 4, so that it is somewhat harder to see as compared with the above described first slipped screen state, as for example, shown in FIG. 31.

Furthermore, by the third slipped screen state, is meant a state in which more displacement than in the case of the above described second slipped screen state is present in the full screen display of the image 20 of the PV on the second liquid crystal display 4, so that it is somewhat harder to see as compared with the above described second slipped screen state, as for example, shown in FIG. 32.

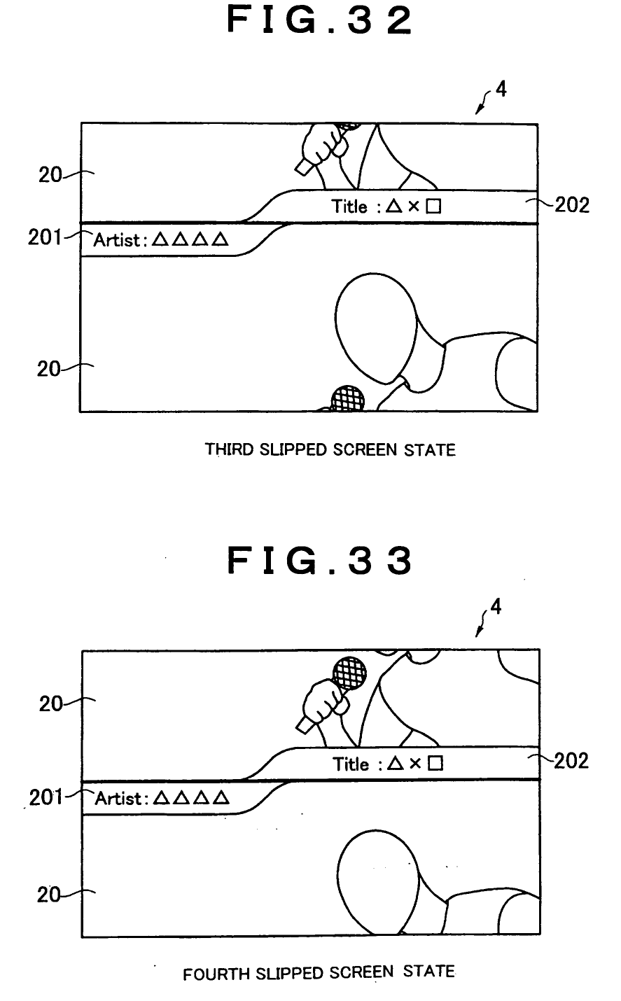

Furthermore, by the fourth slipped screen state, is meant a state in which more displacement than in the case of the above described third slipped screen state is present in the full screen display of the image 20 of the PV on the second liquid crystal display 4, so that it is somewhat harder to see as compared with the above described third slipped screen state, as for example, shown in FIG. 33.

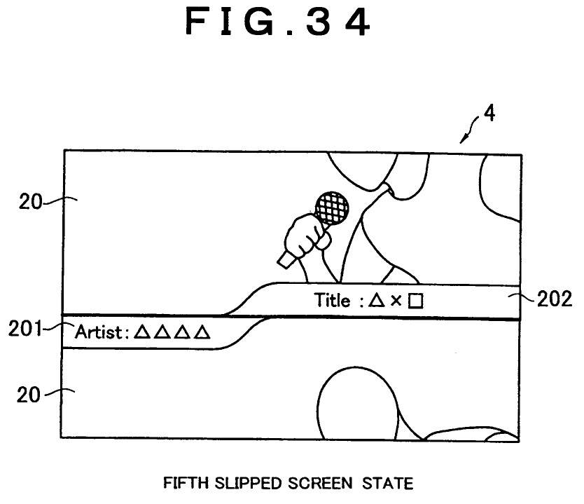

Furthermore, by the fifth slipped screen state, is meant a state in which more displacement than in the case of the above described fourth slipped screen state is present in the full screen display of the image 20 of the PV on the second liquid crystal display 4, so that it is somewhat harder to see as compared with the above described fourth slipped screen state, as for example, shown in FIG. 34.

It should be understood that although, in FIG. 16 and FIGS. 30 through 34, the image 20 shown in FIG. 3A of a PV of a male artist who is singing is displayed, it would also be possible to display the image 20 shown in FIG. 4A of a PV of a female artist who is singing, in the same manner.

And, with the typing game apparatus 1 according to this third preferred embodiment, when the first verse of the song is being reproduced, always, the display state of the image 20 of the PV which is being displayed on the second liquid crystal display 4 is made to be the normal screen state, as for example shown in FIG. 16. However if, after the first verse of the song has been reproduced, the pressing down of the keys corresponding to the Alphabet letters which have been displayed on the lyrics display section 23 of the main screen 21 (refer to FIG. 3B and FIG. 4B) within a predetermined time period has not been continuously performed, or, to express it in another manner, if the condition of non-addition to the error number has not been maintained, then it is not possible for the player to keep the display state of the image 20 of the PV which is being displayed on the second liquid crystal display 4 in the normal screen state.

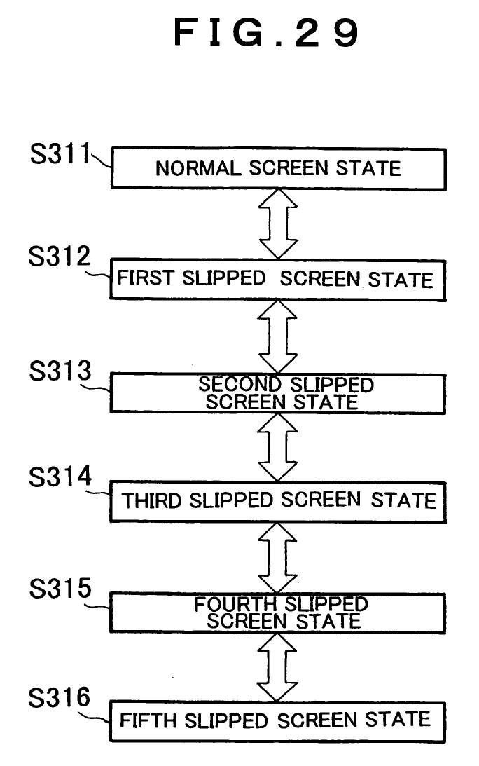

In other words, after the first verse of the song has been reproduced, the display state of the image 20 of the PV which is being displayed on the second liquid crystal display 4 shifts as shown in FIG. 29.

First, when the display state of the image 20 of the PV which is being displayed on the second liquid crystal display 4 is the normal screen state (the step S311), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when 1 has been added to the error number, then the display state of the image 20 of the PV which is being displayed on the second liquid crystal display 4 shifts, for example, from this normal screen state of FIG. 16 to the first slipped screen state of FIG. 30 (the step S312).

Furthermore, when the display state of the image 20 of the PV which is displayed on the second liquid crystal display 4 is the first slipped screen state (S312), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when 1 has been added to the error number, then the display state of the image 20 of the PV which is being displayed on the second liquid crystal display 4 shifts, for example, from this first slipped screen state of FIG. 30 to the second slipped screen state of FIG. 31 (the step S313).

Yet further, when the display state of the image 20 of the PV which is displayed on the second liquid crystal display 4 is the second slipped screen state (the step S313), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when 1 has been added to the error number, then the display state of the image 20 of the PV which is being displayed on the second liquid crystal display 4 shifts, for example, from this second slipped screen state of FIG. 31 to the third slipped screen state of FIG. 32 (the step S314).

Even further, when the display state of the image 20 of the PV which is displayed on the second liquid crystal display 4 is the third slipped screen state (the step S314), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when 1 has been added to the error number, then the display state of the image 20 of the PV which is being displayed on the second liquid crystal display 4 shifts, for example, from this third slipped screen state of FIG. 32 to the fourth slipped screen state of FIG. 33 (the step S315).

Still further, when the display state of the image 20 of the PV which is displayed on the second liquid crystal display 4 is the fourth slipped screen state (the step S315), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when 1 has been added to the error number, then the display state of the image 20 of the PV which is being displayed on the second liquid crystal display 4 shifts, for example, from this fourth slipped screen state of FIG. 33 to the fifth slipped screen state of FIG. 34 (the step S316).

It should be understood that, if the display state of the image 20 of the PV which is displayed on the second liquid crystal display 4 is the fifth slipped screen state (the step S316), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when 1 has been added to the error number, then the display state of the image 20 of the PV which is being displayed on the second liquid crystal display 4 is, for example, maintained at the fifth slipped screen state of FIG. 34 (the step S316).

On the other hand, if the display state of the image 20 of the PV which is displayed on the second liquid crystal display 4 is the fifth slipped screen state (the step S316), when the keys which correspond to the Alphabet letters which have been displayed on the lyrics display section 23 of the main screen 21 (refer to FIG. 3B and FIG. 4B) have been pressed down by the player within the predetermined time period, in other words when the error number has not been added to, then the display state of the image 20 of the PV which is being displayed on the second liquid crystal display 4 shifts, for example, from this fifth slipped screen state of FIG. 34 to the fourth slipped screen state of FIG. 33 (the step S315).

Moreover, if the display state of the image 20 of the PV which is displayed on the second liquid crystal display 4 is the fourth slipped screen state (the step S315), when the keys which correspond to the Alphabet letters which have been displayed on the lyrics display section 23 of the main screen 21 (refer to FIG. 3B and FIG. 4B) have been pressed down by the player within the predetermined time period, in other words when the error number has not been added to, then the display state of the image 20 of the PV which is being displayed on the second liquid crystal display 4 shifts, for example, from this fourth slipped screen state of FIG. 33 to the third slipped screen state of FIG. 32 (the step S314).

Furthermore, if the display state of the image 20 of the PV which is displayed on the second liquid crystal display 4 is the third slipped screen state (the step S314), when the keys which correspond to the Alphabet letters which have been displayed on the lyrics display section 23 of the main screen 21 (refer to FIG. 3B and FIG. 4B) have been pressed down by the player within the predetermined time period, in other words when the error number has not been added to, then the display state of the image 20 of the PV which is being displayed on the second liquid crystal display 4 shifts, for example, from this third slipped screen state of FIG. 32 to the second slipped screen state of FIG. 31 (the step S313).

Yet further, if the display state of the image 20 of the PV which is displayed on the second liquid crystal display 4 is the second slipped screen state (the step S313), when the keys which correspond to the Alphabet letters which have been displayed on the lyrics display section 23 of the main screen 21 (refer to FIG. 3B and FIG. 4B) have been pressed down by the player within the predetermined time period, in other words when the error number has not been added to, then the display state of the image 20 of the PV which is being displayed on the second liquid crystal display 4 shifts, for example, from this second slipped screen state of FIG. 31 to the first slipped screen state of FIG. 30 (the step S312).

Even further, if the display state of the image 20 of the PV which is displayed on the second liquid crystal display 4 is the first slipped screen state (the step S312), when the keys which correspond to the Alphabet letters which have been displayed on the lyrics display section 23 of the main screen 21 (refer to FIG. 3B and FIG. 4B) have been pressed down by the player within the predetermined time period, in other words when the error number has not been added to, then the display state of the image 20 of the PV which is being displayed on the second liquid crystal display 4 shifts, for example, from this first slipped screen state of FIG. 30 to the normal screen state of FIG. 16 (the step S311).

Finally, if the display state of the image 20 of the PV which is displayed on the second liquid crystal display 4 is the normal screen state (the step S311), when the keys which correspond to the Alphabet letters which have been displayed on the lyrics display section 23 of the main screen 21 (refer to FIG. 3B and FIG. 4B) have been pressed down by the player within the predetermined time period, in other words when the error number has not been added to, then the display state of the image 20 of the PV which is being displayed on the second liquid crystal display 4 is maintained, for example, in the normal screen state of FIG. 16 (the step S311).

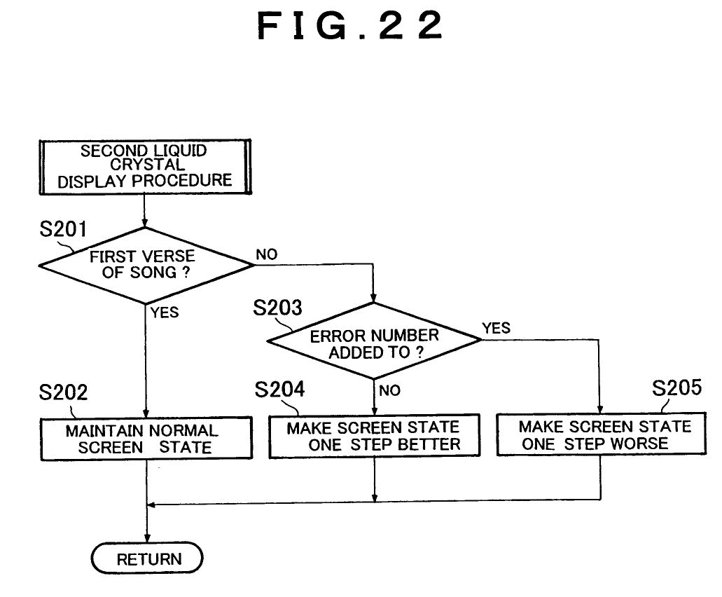

However, for this, at the time point W2 at which the flow of control returns from the step S34 of the typing game execution procedure shown in FIG. 13 to the step S27, a second liquid crystal display procedure shown in FIG. 22 must be executed. This second liquid crystal display procedure will now be explained with reference to FIG. 22. FIG. 22 is a flow chart showing the second liquid crystal display processing program of the typing game apparatus according to this third embodiment.

And, with the typing game apparatus 1 of this embodiment, as described above, in order to control the display state of the image 20 of the PV which is displayed on the second liquid crystal display 4, at the time point W2 at which the flow of control returns from the step S34 of the typing game execution procedure shown in FIG. 13 to the step S27, a second liquid crystal display procedure shown in FIG. 22 is executed. Here, this second liquid crystal display procedure will be explained with reference to FIG. 22. FIG. 22 is a flow chart showing the second liquid crystal display processing program of the typing game apparatus according to this second embodiment.

As shown in FIG. 22, in this second liquid crystal display procedure, first, in a step S201, a determination is made as to whether or not the first verse of the song is being reproduced. If it is determined that, at this time, the first verse of the song is being reproduced, (S201: YES), then the flow of control proceeds to a step S202, and the display state for the image 20 of the PV which is being displayed on the second liquid crystal display 4 is maintained in the present state; in other words, for example, the normal screen state as shown in FIG. 16 is maintained, and thereafter the flow of control goes back to the typing game execution procedure shown in FIG. 13, and returns to the step S27.

On the other hand, if it has been determined that it is not the first verse of the song which is being reproduced (S201: NO), then the flow of control proceeds to a step S203, in which it is determined whether or not the error number has been added to. Here by addition to the error number is meant, that 1 was added to the error number in the step S30 or in the step S28 of the typing game execution procedure shown in FIG. 13 which was performed directly before this procedure.

If, at this time, it has been determined that addition to the error number has not been performed (S203: NO), then the flow of control proceeds to the step S204, and the display state of the image 20 of the PV which is being displayed on the second liquid crystal display 4 is made one step better. Thereafter, the flow of control goes back to the typing game execution procedure shown in FIG. 13, and returns to the step S27.

Here, to make the display state of the image 20 of the PV which is being displayed on the second liquid crystal display 4 one step better, means any of: to maintain the normal screen state (i.e. to maintain the step S311 of FIG. 29), or to shift from the first slipped screen state to the normal screen state (i.e. to shift from the step S312 of FIG. 29 to the step S311), or to shift from the second slipped screen state to the first slipped screen state (i.e. to shift from the step S313 of FIG. 29 to the step S312), or to shift from the third slipped screen state to the second slipped screen state (i.e. to shift from the step S314 of FIG. 29 to the step S313), or to shift from the fourth slipped screen state to the third slipped screen state (i.e. to shift from the step S315 of FIG. 29 to the step S314), or to shift from the fifth slipped screen state to the fourth slipped screen state (i.e. to shift from the step S316 of FIG. 29 to the step S315).

On the other hand, if it has been determined that error number addition has been performed (S203: YES), then the flow of control proceeds to the step 205, and the display state of the image 20 of the PV which is being displayed on the second liquid crystal display 4 is made one step worse, and thereafter the flow of control goes back to the typing game execution procedure shown in FIG. 13, and returns to the step S27.

Here, to make the display state of the image 20 of the PV which is being displayed on the second liquid crystal display 4 one step worse, means any of: to shift from the normal screen state to the first slipped screen state (i.e. to shift from the step S311 of FIG. 29 to the step S312), or to shift from the first slipped screen state to the second slipped screen state (i.e. to shift from the step S312 of FIG. 29 to the step S313), or to shift from the second slipped screen state to the third slipped screen state (i.e. to shift from the step S313 of FIG. 29 to the step S314), or to shift from the third slipped screen state to the fourth slipped screen state (i.e. to shift from the step S314 of FIG. 29 to the step S315), or to shift from the fourth slipped screen state to the fifth slipped screen state (i.e. to shift from the step S315 of FIG. 29 to the step S316), or to maintain the fifth slipped screen state (i.e. to maintain the step S316 of FIG. 29).

Accordingly, when executing the step S201, the CPU 51 functions as a “first condition determination means”.

And, when executing the step S203, the CPU 51 functions as a “second condition determination means”.

Yet further, when executing the step S23 and the step S202, the CPU 51 and the display control circuit 60 function as a “full screen display control means”.

Even further, when executing the step S205, the CPU 51 and the display control circuit 60 function as a “screen disordering display control means”.

Still further, when executing the step S204, the CPU 51 and the display control circuit 60 function as a “disordering elimination display control means”.

In other words, with the typing game apparatus 1 according to this third embodiment, on the one hand, since, when the section of the song which is being reproduced is not its first verse (S201: NO), when some key has been pressed down by the player other than a key which corresponds to the Alphabet letters which have been displayed on the lyrics display section 23 of the main screen 21 (refer to FIG. 3B and FIG. 4B), or when no key input has been performed by the player even though the predetermined time period has elapsed, in other words when it is determined (S203: YES) that 1 has been added to the error number, so that the evaluation related to typing is in an unfavorable state, then the display state of the image 20 of the PV which is being displayed on the second liquid crystal display 4 is made one step worse (in the step S205), i.e., as shown by the order of FIG. 16 and FIG. 30 to FIG. 34, the displacement of the screen of the second liquid crystal display 4 on which the image 20 of the PV of this song is being displayed is made more severe, so that it is possible for the skill related to typing to appeal to the onlookers via the state of the display of the image 20 of the PV, which possesses an attractiveness which entices the public; and, on the other hand since, only when the section of the song which is being reproduced is its first verse (S201: YES), then, as shown in FIG. 16, the image 20 of the PV of this song is always displayed clearly in a full screen manner on the second liquid crystal display 4 without any displacement being generated therein (in the step S202), accordingly it is possible sufficiently to manifest a beneficial effect for publicity directed towards the promotion of the sales of a CD or a DVD or the like which contains image data.

Furthermore since, when the section of the song which is being reproduced is not its first verse (S201: NO), when it is determined (S203: NO) that a key has been pressed down which corresponds to the Alphabet letters which have been displayed on the lyrics display section 23 of the main screen 21 (refer to FIG. 3B and FIG. 4B), and moreover that key input has been performed by the player within the predetermined time period, in other words that 1 has not been added to the error number, so that the evaluation related to typing is in a favorable state, then the display state of the image 20 of the PV which is being displayed on the second liquid crystal display 4 is made one step better (in the step S204), i.e., as shown by the order of FIG. 34 to FIG. 30 and FIG. 16, the displacement of the screen of the second liquid crystal display 4 on which the image 20 of the PV of this song is being displayed is made progressively better, so that it is possible for the skill related to typing to appeal to the onlookers via the state of the display of the image 20 of the PV, which possesses an attractiveness which entices the public.

It should be understood that it would also be acceptable to arrange matters so that, if the score has been added to, in other words if a key has been pressed down which corresponds to the Alphabet letters which have been displayed on the lyrics display section 23 of the main screen 21 (refer to FIG. 3B and FIG. 4B), and moreover key input has been performed by the player within the predetermined time period, or if it has been determined that a character has been typed (struck) which corresponds at the same timing to the voice of the song which is being performed, the evaluation related to typing is considered to be in a favorable state, then the display state of the image 20 of the PV which is being displayed on the second liquid crystal display 4 is made one step better, i.e., as shown by the order of FIG. 34 to FIG. 30 and FIG. 16, the displacement of the screen of the second liquid crystal display 4 on which the image. 20 of the PV of this song is being displayed is made progressively better, so that it is possible for the skill related to typing to appeal to the onlookers via the state of the display of the image 20 of the PV, which possesses an attractiveness which entices the public.

Furthermore, although the displacement of the screen of the second liquid crystal display 4 on which the image 20 of the PV of the song which was being performed was fixed and became larger in the order: the first slipped screen state of FIG. 30—the second slipped screen state of FIG. 31—the third slipped screen state of FIG. 32—the fourth slipped screen state of FIG. 33—the fifth slipped screen state of FIG. 34, alternatively, it would also be acceptable to arrange for the speed of shifting in the vertical direction of these screens to be make quicker.

Yet further, with regard to the three second liquid crystal display procedures during the typing game execution procedure shown in FIG. 13 which were shown using FIG. 14 and FIG. 22, it would also be acceptable to perform only one of them, or to perform two or more of them simultaneously, and moreover it would also be acceptable to perform exchange of the time point W1 and the time point W2, which is the timing of their execution.

Even further, if at least of two of the three second liquid crystal display procedures during the typing game execution procedure shown in FIG. 13 which were shown using FIG. 14 and FIG. 22 are performed simultaneously, it would also be acceptable, as the display state of the image 20 of the PV which is being displayed on the second liquid crystal display 4, for at least two of the screen states among the divided screen states shown in FIG. 17 through FIG. 21, the noisy screen states shown in FIG. 24 through FIG. 28, and the slipped screen states shown in FIG. 30 through FIG. 34, to be displayed in an overlapped state.

Yet further, with the above described embodiments, only when the song which was being reproduced is in its first verse (S101: YES; S201: YES), always, as shown in FIG. 16, the image 20 of the PV which is being displayed on the second liquid crystal display 4 is displayed full screen in a beautiful manner (S102, S202). Moreover, when a song related to the image 20 of the PV is presented, it is usual for the beneficial effect which the image 20 of the PV has with regard to publicity aimed at promotion of sales of a CD or a DVD to diminish progressively along with time.

Thus it would also be acceptable, if a song is being reproduced for which a predetermined time period (for example 6 months) has not elapsed from when it was updated by the server 80, then to attach great importance to the fact that the beneficial effect which the image 20 of the PV has with regard to publicity aimed at promotion of sales of a CD or a DVD, and, always, as shown in FIG. 16, to display the image 20 of the PV of this song on the second liquid crystal in a full screen manner, so that, by this beautiful image 20 of the PV being shown to the onlookers, a desire to purchase the CD or DVD of the song related to the image 20 of this PV may make a deep effect on the hearts of the onlookers; while, on the other hand, if a song is being reproduced for which the predetermined time period (for example 6 months) has elapsed from when it was updated by the server 80, then to attach great importance to the aspect of appealing the skill related to typing to the onlookers via the state of the display of the image 20 of the PV which possesses an attractiveness which entices the public, and thus, when the evaluation related to typing is in an unfavorable state, to make the display state of the image 20 of the PV which is being displayed on the second liquid crystal display 4 one step worse, while, when the evaluation related to typing is in a favorable state, to make the display state of the image 20 of the PV which is being displayed on the second liquid crystal display 4 one step better.

Furthermore, in these above described embodiments, when the song which was being reproduced was in its first verse (S101: YES; S201: YES), then always, as shown in FIG. 16, the image 20 of the PV of this song was displayed full screen in a beautiful manner on the second liquid crystal display 4 (S102, S202), while on the other hand, when the song which was being reproduced was not in its first verse (S101: NO; S201: NO), then, when the evaluation related to typing was in an unfavorable state (S103: NO; S203: YES), the image 20 of the PV of this song was made one step worse (S105, S205), while, when the evaluation related to typing was in a favorable state (S103: YES; S203: NO), the image 20 of the PV of this song was made one step better (S104, S204). Conversely, it would also be acceptable, when the song which was being reproduced is in its first verse (S101: YES; S201: YES), when the evaluation related to typing is in an unfavorable state (S103: NO; S203: YES), to make the image 20 of the PV of this song one step worse (S105, S205), while, when the evaluation related to typing is in a favorable state (S103: YES; S203: NO), to make the image 20 of the PV of this song one step better (S104, S204); while, when the song which was being reproduced is not in its first verse (S101: NO; S201: NO), always, as shown in FIG. 16, to display the image 20 of the PV of this song full screen in a beautiful manner on the second liquid crystal display 4 (S102, S202).

Yet further, with the typing game apparatus 1 according to these embodiments, if a plurality of songs are reproduced continuously, it would also be acceptable, while the first song is being performed, always, as shown in FIG. 16, to display the image 20 of the PV of this song full screen in a beautiful manner on the second liquid crystal display 4, while on the other hand, while the following and subsequent songs are being performed, when the evaluation related to typing is in an unfavorable state, to make the image 20 of the PV of this song which is displayed on the second liquid crystal display 4 one step worse, and, when the evaluation related to typing is in a favorable state, to make the image 20 of the PV of this song which is displayed on the second liquid crystal display 4 one step better; or, conversely, while the first song is being performed, when the evaluation related to typing is in an unfavorable state, to make the image 20 of the PV of this song which is displayed on the second liquid crystal display 4 one step worse, and, when the evaluation related to typing is in a favorable state, to make the image 20 of the PV of this song which is displayed on the second liquid crystal display 4 one step better, while on the other hand, while the following and subsequent songs are being performed, always, as shown in FIG. 16, to display the image 20 of the PV of this song full screen in a beautiful manner on the second liquid crystal display 4.

Even further, with these above described embodiments, when the evaluation related to typing is in an unfavorable state (S103: NO; S203: YES), then the image 20 of the PV of this song is made one step worse (S105, S205), while, when the evaluation related to typing is in a favorable state (S103: YES; S203: NO), then the image 20 of the PV of this song is made one step better (S104, S204). However, it would also be acceptable to make the display state of the main game screen 21 which is being displayed on the first liquid crystal display 3 one step worse, and one step better.

Still further, the typing game apparatus 1 according to these embodiments is connected to the server 80 via the network N such as the internet or the like capable of performing bi-directional communication, so that, based on data which is transmitted from the server 80, the image data and the music data stored on the HDD 55 (refer to FIG. 9) of the typing game apparatus 1 can be updated; but it would also be acceptable to make such a typing game apparatus as a device independent of any server 80, on which the image data and the music data can be updated.

Moreover although, by way of example, as the typing game apparatus according to the present invention, a typing game apparatus 1 of a housing type which is set up in a game arcade or the like was explained, it would also be acceptable to apply the present invention to a typing game apparatus consisting of a PC having two screens on which was installed software relating to a typing game. It should be understood that the present invention could also be applied to software related to a typing game in which two display regions are displayed on a single display screen.

What is claimed is:

1. A typing game apparatus, comprising:
a storage unit, on which are stored image data and music data including, at least, musical instrument data, voice data, lyrics data, and determination standard data;
a musical performance processing unit which performs a song by outputting a musical instrument and a voice, based on said music data stored in said storage unit;
a first image display on which predetermined character strings which are parts of lyrics of said song are displayed in order while being matched with a progression of said song which is being performed by said musical performance processing unit;
a second image display on which said image data stored in said storage unit is displayed;
an image display control unit which controls an operation of said first image display and said second image display, based on said music data stored in said storage unit;
an input unit on which are arranged a plurality of keys which correspond to a plurality of characters;
a correctness determination unit which determines, with a determination standard based on said music data stored in said storage unit, whether or not a character string, which is input by typing by pressing down keys of said input unit, agrees with said predetermined character string;
a play development control unit which controls a development of play, based on a determination result of said correctness determination unit;
a first condition determination unit which determines whether or not a first condition in which a predetermined state holds for the song which is being performed by said musical performance processing unit is satisfied;
a normal screen display control unit which, if it is determined by said first condition determination unit that said first condition is satisfied, causes said second image display to perform an operation to display said image data stored in said storage unit in a normal screen state;
a second condition determination unit which determines whether or not a second condition in which a result of determination by said correctness determination unit is at or above a predetermined standard is satisfied; and
an abnormal screen display control unit which, if it is determined by said first condition determination unit that said first condition is not satisfied, and when evaluation related to said typing on said input unit is in an unfavorable state due to a determination by said second condition determination unit that said second condition is not satisfied, causes said second image display to perform an operation to display a screen in which said image data stored in said storage unit is displayed in an abnormal screen state which is different from said normal screen state.

2. The typing game apparatus according to claim 1, wherein said normal screen display control unit comprises a full screen display control unit which causes said second image display to perform an operation to display said image data stored in said storage unit in a full screen state; and
wherein said abnormal screen display control unit comprises a screen division display control unit which causes said second image display to perform an operation to divide into a plurality of sections a screen in which said image data stored in said storage unit is displayed.

3. The typing game apparatus according to claim 2, further comprising a division cancellation display control unit which, if it is determined by said first condition determination unit that said first condition is not satisfied, and when the evaluation relating to said typing on said input unit is in a favorable state due to a determination by said second condition determination unit that said second condition is satisfied, causes said second image display to perform an operation to cancel screen division of the display of said image data stored in said storage unit.

4. The typing game apparatus according to claim 2, wherein said input unit comprises a keyboard, and, in an interior of each key on said keyboard, there is provided an LED section which emits light of a first color if input operation via said key is correct, and emits light of a second color if said input operation via said key is incorrect.

5. The typing game apparatus according to claim 2, wherein said screen division display control unit is changeable from a full screen display in which the screen is not divided to a 4-division screen display, and furthermore is changeable from said 4-division screen display to a 16-division screen display.

6. The typing game apparatus according to claim 2, wherein the operation of dividing said screen by said screen division display control unit is performed when a typing error has occurred during a character input.

7. The typing game apparatus according to claim 3, wherein the operation of canceling said screen division by said division cancellation display control unit is performed when an input of a predetermined number of characters has been performed without any typing errors.

8. The typing game apparatus according to claim 1, wherein said normal screen display control unit comprises a full screen display control unit which causes said second image display to perform an operation to display said image data stored in said storage unit in a full screen state; and
wherein said abnormal screen display control unit comprises a screen disordering display control unit which causes said second image display to perform an operation to disorder a screen in which said image data stored in said storage unit is displayed.

9. The typing game apparatus according to claim 8, further comprising a disordering elimination display control unit which, if it is determined by said first condition determination unit that said first condition is not satisfied, and when the evaluation relating to typing on said input unit is in a favorable state due to a determination by said second condition determination unit that said second condition is satisfied causes said second image display to perform an operation to eliminate screen disordering of the display of said image data stored in said storage unit.

10. The typing game apparatus according to claim 8, wherein the disordering of the image data on said display screen of said second image display comprises generation of noise therein.

11. The typing game apparatus according to claim 8, wherein the disordering of the image data on said display screen of said second image display comprises generation of displacement thereof on said display screen.

12. The typing game apparatus according to claim 11, wherein said displacement on said display screen of the image data of said second image display comprises shifting of said display screen in a vertical direction.

13. The typing game apparatus according to claim 8, wherein said input unit comprises a keyboard, and, in an interior of each key on said keyboard, there is provided a LED section which emits light of a first color if input operation via said key is correct, and emits light of a second color if said input operation via said key is incorrect.

14. The typing game apparatus according to claim 8, wherein said screen disordering display control unit is changeable from a screen display in which no noise is generated to a first stage noisy screen display in which noise is generated to a first extent, and furthermore is changeable from said first stage noisy screen display to a second stage noisy screen display in which more noise is generated than in said first stage noisy screen display.

15. The typing game apparatus according to claim 14, wherein a change operation of said noisy screen display by said screen disordering display control unit is performed when a typing error in a character input has occurred.

16. The typing game apparatus according to claim 14, wherein the operation of eliminating noise generation on said screen by said disordering elimination display control unit is performed when an input of a predetermined number of characters has been performed without any typing errors.

17. The typing game apparatus according to claim 12, wherein said screen disordering display control unit is changeable from a screen display in which no shifting of said display screen in the vertical direction is generated to a first stage shifted screen display in which shifting of said display screen in the vertical direction to a first extent is generated, and furthermore is changeable from said first stage shifted screen display to a second stage shifted screen display in which more shifting of said display screen in the vertical direction is generated than in said first stage shifted screen display.

18. The typing game apparatus according to claim 17, wherein a change operation of said shifted screen display by said screen disordering display control unit is performed when a typing error has occurred in a character input.

19. The typing game apparatus according to claim 17, wherein the operation of eliminating shifting of said screen in the vertical direction by said disordering elimination display control unit is performed when input of a predetermined number of characters has been performed without any typing errors.
